(19) United States
(12) Patent Application Publication
(10) Pub. No.: US 2025/0119941 A1
(43) Pub. Date: Apr. 10, 2025

(54) METHOD FOR COORDINATED SENSING MEASUREMENT AND DEVICE

(71) Applicant: GUANGDONG OPPO MOBILE TELECOMMUNICATIONS CORP., LTD., Dongguan (CN)

(72) Inventors: Ning GAO, Dongguan (CN); Lei HUANG, Singapore (SG); Chaoming LUO, Dongguan (CN); Pei ZHOU, Dongguan (CN)

(21) Appl. No.: 18/962,842

(22) Filed: Nov. 27, 2024

Related U.S. Application Data
(63) Continuation of application No. PCT/CN2022/107539, filed on Jul. 22, 2022.

(51) Int. Cl. H04W 74/06; H04L 5/00; H04W 24/10

(52) U.S. Cl. CPC H04W 74/06; H04L 5/0053; H04W 24/10

(57) ABSTRACT

Provided is a method for coordinated sensing measurement. The method for coordinated sensing measurement is applicable to a sensing initiator and includes during a coordinated sensing measurement, triggering each group of or each of sensing responders that participate in the coordinated sensing measurement to execute all or a portion of stages in a sensing measurement process in a poll triggering mode.

### CROSS-REFERENCE TO RELATED APPLICATION

This application is a continuation of International Application No. PCT/CN2022/107539, filed Jul. 22, 2022, the entire disclosure of which is incorporated herein by reference.

### TECHNICAL FIELD

The present disclosure relates to the field of sensing measurement, and in particular, relates to methods and apparatuses for coordinated sensing measurement, devices, and a storage medium.

### BACKGROUND

Wireless local area network (WLAN) sensing refers to a technology for sensing a person or an object in an environment by measuring changes in WLAN signals by scattering and/or reflecting by the person or the object.

In coordinated sensing measurement, no less than two devices participate in coordinated sensing, which generally includes one sensing initiator and at least one sensing responder. The sensing initiator is configured to control all sensing responders to achieve coordinated sensing.

### SUMMARY

The present disclosure provides methods and apparatuses for coordinated sensing measurement, devices, and a storage medium. The technical solutions are as follows.

According to some embodiments of the present disclosure, a method for coordinated sensing measurement is provided. The method is applicable to a sensing initiator, and the method includes:

during the coordinated sensing measurement, triggering each group of or each of sensing responders that participate in the coordinated sensing measurement to execute all or a portion of stages in a sensing measurement process in a poll triggering mode.

According to some embodiments of the present disclosure, a method for coordinated sensing measurement is provided. The method is applicable to a sensing responder, and the method includes:
during the coordinated sensing measurement, executing, by each group of or each of the sensing responders that participate in the coordinated sensing measurement, all or a portion of stages in a sensing measurement process based on a trigger by a sensing initiator in a poll triggering mode.

According to some embodiments of the present disclosure, a sensing initiating device is provided. The device includes:
a processor;
a transceiver, connected to the processor; and
a memory, configured to store one or more executable instructions of the processor,
where the processor, when loading and executing the one or more executable instructions, is caused to perform the methods for coordinated sensing measurement as defined in the above embodiments.

According to some embodiments of the present disclosure, a sensing responding device is provided. The device includes:
a processor;
a transceiver, connected to the processor; and
a memory, configured to store one or more executable instructions of the processor,
where the processor, when loading and executing the one or more executable instructions, is caused to perform the methods for coordinated sensing measurement as defined in the above embodiments.

### BRIEF DESCRIPTION OF THE DRAWINGS

For describing the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a sensing measurement system according to some embodiments of the present disclosure;

FIG. 2 is a schematic diagram of millimeter-wave sensing types according to some embodiments of the present disclosure;

FIG. 3 is a schematic diagram of a millimeter-wave sensing flow according to some embodiments of the present disclosure;

FIG. 4 is a schematic diagram of a sequential mode of millimeter-wave coordinated-monostatic sensing measurement according to some embodiments of the present disclosure;

FIG. 5 is a schematic diagram of a parallel mode of millimeter-wave coordinated-monostatic sensing measurement according to some embodiments of the present disclosure;

FIG. 6 is a schematic diagram of millimeter-wave coordinated-bistatic sensing measurement according to some embodiments of the present disclosure;

FIG. 7 is a schematic diagram of the format of a beamforming frame according to some embodiments of the present disclosure;

FIG. 8 is a schematic diagram of the format of a sensing request frame according to some embodiments of the present disclosure;

FIG. 9 is a schematic diagram of the format of a sensing response frame according to some embodiments of the present disclosure;

FIG. 10 is a schematic diagram of the format of a sensing poll frame according to some embodiments of the present disclosure;

FIG. 11 is a flowchart of a method for coordinated sensing measurement according to some embodiments of the present disclosure;

FIG. 12 is a flowchart of a method for coordinated sensing measurement according to some embodiments of the present disclosure;

FIG. 13 is a schematic diagram of the format of a sensing measurement poll frame according to some embodiments of the present disclosure;

FIG. 14 is a schematic diagram of the format of a sensing measurement poll frame according to some embodiments of the present disclosure;

FIG. 15 is a flowchart of a method for coordinated sensing measurement according to some embodiments of the present disclosure;

FIG. 16 is a schematic flowchart of a sequential mode of coordinated-monostatic sensing measurement according to some embodiments of the present disclosure;

FIG. 17 is a flowchart of a method for coordinated sensing measurement according to some embodiments of the present disclosure;

FIG. 18 is a schematic flowchart of a sequential mode of coordinated-monostatic sensing measurement according to some embodiments of the present disclosure;

FIG. 19 is a flowchart of a method for coordinated sensing measurement according to some embodiments of the present disclosure;

FIG. 20 is a schematic flowchart of a sequential mode of coordinated-monostatic sensing measurement according to some embodiments of the present disclosure;

FIG. 21 is a flowchart of a method for coordinated sensing measurement according to some embodiments of the present disclosure;

FIG. 22 is a schematic flowchart of a parallel mode of coordinated-monostatic sensing measurement according to some embodiments of the present disclosure;

FIG. 23 is a flowchart of a method for coordinated sensing measurement according to some embodiments of the present disclosure;

FIG. 24 is a schematic flowchart of a parallel mode of coordinated-monostatic sensing measurement according to some embodiments of the present disclosure;

FIG. 25 is a flowchart of a method for coordinated sensing measurement according to some embodiments of the present disclosure;

FIG. 26 is a schematic flowchart of coordinated-bistatic sensing measurement according to some embodiments of the present disclosure;

FIG. 27 is a flowchart of a method for coordinated sensing measurement according to some embodiments of the present disclosure;

FIG. 28 is a schematic flowchart of coordinated-bistatic sensing measurement according to some embodiments of the present disclosure;

FIG. 29 is a flowchart of a method for coordinated sensing measurement according to some embodiments of the present disclosure;

FIG. 30 is a schematic flowchart of coordinated-bistatic sensing measurement according to some embodiments of the present disclosure;

FIG. 31 is a block diagram of an apparatus for coordinated sensing measurement according to some embodiments of the present disclosure;

FIG. 32 is a block diagram of an apparatus for coordinated sensing measurement according to some embodiments of the present disclosure; and

FIG. 33 is a schematic structural diagram of a sensing measurement device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings. Reference is made in detail to the exemplary embodiments, examples of which are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a”, “an”, and “the” are intended to include the plural forms as well, unless the context clearly indicates otherwise. It should also be understood that the term “and/or” as used herein refers to and encompasses any or all possible combinations of one or more associated listed items.

It should be understood that although the terms “first”, “second”, “third”, etc. may be used herein to describe various information, such information should not be limited to these terms. These terms are only used to distinguish one type of information from another. For example, first information may also be referred to as second information, and similarly, second information is also referred to as first information, without departing from the scope of the present disclosure. The word “if”, as used herein, may be interpreted as “in the case that”, “in the case of”, or “in response to determining that”, depending on the context.

First, some terms involved in the embodiments of the present disclosure are described as follows.

WLAN sensing refers to a technology for sensing a person or an object in an environment by measuring changes in WLAN signals by scattering and/or reflecting by the person or the object. That is, the WLAN sensing measures and senses the surrounding environment by wireless signals, such that various functions can be completed, such as detection of whether someone intrudes/moves/falls indoors, gesture recognition, and establishment of three-dimensional spatial images.

An association identifier (AID) is configured to identify a terminal that has established an association with an access point.

WLAN devices that participate in the WLAN sensing may include a sensing initiator, a sensing responder, a sensing transmitter, and a sensing receiver.

The sensing initiator is also referred to as a sensing session initiator, a sensing initiating device, and an initiator, and the sensing initiator is a device that initiates sensing measurement and desires to learn a sensing result.

The sensing responder is also referred to as a sensing session responder, a sensing responding device, and a responder, and the sensing responder is a device that participates in the sensing measurement and is not a sensing initiating device.

The sensing transmitter is also referred to as a sensing transmitting device, a sensing signal transmitter, a sensing signal transmitting device, and a transmitter, and the sensing transmitter is a device that transmits a sensing physical layer protocol data unit (PPDU).

The sensing receiver is also referred to as a sensing receiving device, a sensing signal receiver, a sensing signal receiving device, and a receiver. The sensing receiver is a device that receives an echo signal. The echo signal is acquired by scattering and/or reflecting for the sensing physical layer protocol data unit transmitted by the sensing transmitter by people or objects.

A WLAN terminal plays one or more roles in the sensing measurement. For example, the sensing initiator is only a sensing initiator, a sensing transmitter, a sensing receiver, or both a sensing transmitter and a sensing receiver. The devices described above are collectively referred to as sensing measurement devices.

Next, the technical background related to the embodiments of the present disclosure is described as follows.

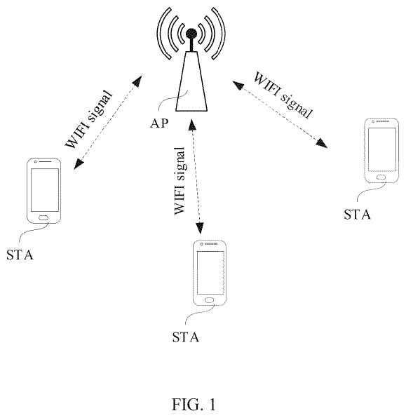

FIG. 1 is a block diagram of a sensing measurement system according to some embodiments of the present disclosure. The sensing measurement system includes a terminal and a terminal, or a terminal and a network device, or an access point (AP) and a station (STA), which is not limited in the present disclosure. In the present disclosure, the sensing measurement system is illustrated as including the AP and the STA.

In some scenarios, the AP is also referred to as an AP STA, which means that, in a certain sense, the AP is also a type of STA. In some scenarios, the STA is also referred to as a non-AP STA.

In some embodiments, STAs include an AP STA and a non-AP STA.

The communication within the communication system involves communication between the AP and the non-AP STA, between non-AP STAs, or between the STA and a peer STA, where the peer STA refers to a device communicating with the STA at an opposite terminal. For example, the peer STA may be an AP or a non-AP STA.

The AP functions as a bridge connecting the wired network and the wireless network, primarily serving to connect various wireless network clients together and then access the wireless network to the Ethernet. AP devices may be terminal devices (such as mobile phones) or network devices (such as routers) equipped with wireless-fidelity (WiFi) chips.

It should be understood that the role of the STA in the communication system is not absolute. For example, in some scenarios, in the case that a mobile phone connects to a router, the mobile phone acts as a non-AP STA. However, in the case that the mobile phone serves as a hotspot for other mobile phones, it takes on the role of an AP.

Both the AP and the non-AP STA may be devices applied in the Internet of Vehicles, nodes and sensors in Internet of Things (IoT), smart cameras, smart remotes, smart water meters, and electricity meters in smart homes, as well as sensors in smart cities.

In some embodiments, the non-AP STA supports, but is not limited to, the 802.11bf standard. The non-AP STA may also support various current and future WLAN standards of the 802.11 family, such as 802.11ax, 802.11ac, 802.11n, 802.11g, 802.11b, and 802.11a.

In some embodiments, the AP is a device that supports the 802.11bf standard. The AP may also be a device that supports various current and future WLAN standards of the 802.11 family, such as 802.11ax, 802.11ac, 802.11n, 802.11g, 802.11b, and 802.11a.

In the embodiments of the present disclosure, the STA may be devices that support WLAN/WiFi technology, such as mobile phones, tablets (Pads), computers, virtual reality (VR) devices, augmented reality (AR) devices, wireless devices in industrial control, set-top boxes, wireless devices in self-driving, in-vehicle communication devices, wireless devices in remote medical applications, wireless devices in smart grids, wireless devices in transportation safety, wireless devices in smart cities, wireless devices in smart homes, and wireless communication chips/ASIC/SOC.

Frequency bands supported by the WLAN technology include but are not limited to low-frequency bands (2.4 GHz, 5 GHZ, and 6 GHz) and a high-frequency band (60 GHz).

One or more links are present between the station and the access point.

In some embodiments, the station and the access point support multi-band communications, e.g., simultaneous communications at 2.4 GHz, 5 GHZ, 6 GHZ, and 60 GHz bands, or simultaneous communications in different channels of the same frequency band (or different frequency bands), improving the communication throughput and/or reliability between devices. Such devices are often referred to as multi-band devices, or multi-link devices (MLDs), and are sometimes referred to as multi-link entities or multi-band entities. The multi-link device may be an access point device or a station device. In the case that the multi-link device is the access point device, one or more APs are included in the multi-link device; and in the case that the multi-link device is the station device, one or more non-AP STAs are included in the multi-link device.

The multi-link device including one or more APs is also referred to as an AP, and the multi-link device including one or more non-AP STAs is also referred to as a non-AP. In the embodiments of the present disclosure, the non-AP is also referred to as an STA.

In the embodiments of the present disclosure, the AP may include a plurality of APs, the non-AP may include a plurality of STAs, a plurality of links may be formed between the APs in the AP and the STAs in the non-AP, and data communication may be performed between the APs in the AP and the corresponding STAs in the non-AP through the corresponding links.

The AP is a device deployed in a wireless local area network to provide a wireless communication function for the STA. The station may include user equipment (UE), an access terminal, a subscriber unit, a subscriber station, a rover station, a mobile station, a remote station, a remote terminal, a mobile device, a wireless communication device, a user agent, or a user apparatus. In some embodiments, the station is a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, or a wearable device, which is not limited in the embodiments of the present disclosure.

In the embodiments of the present disclosure, both the station and the access point support the IEEE 802.11 standard, but are not limited to the IEEE 802.11 standard. The station and the access point may support other standards related to sensing measurement, such as the IEEE 802.11 bf D0.1 standard.

In the WLAN sensing scenario, WLAN terminals involved in the sensing include a sensing initiator and a sensing responder. Further, the sensing responder may be divided into a sensing transmitter and a sensing receiver.

The sensing measurement is applicable to a cellular network communication system, a wireless local area network (WLAN) system, or a wireless-fidelity (WiFi) system, which is not limited in the present disclosure. In the present disclosure, the sensing measurement is illustrated as being applied to the WLAN or WiFi system.

In some embodiments, the coordinated sensing measurement in the embodiments of the present disclosure is implemented based on millimeter-waves. The millimeter-wave sensing types are described hereinafter.

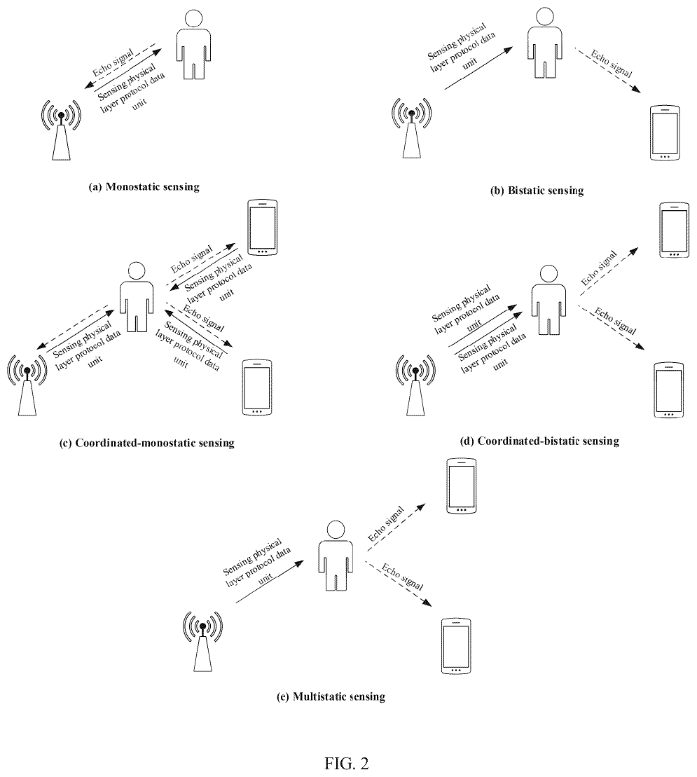

FIG. 2 is a schematic diagram of millimeter-wave sensing types according to some embodiments of the present disclosure. As shown in FIG. 2, (a) of FIG. 2 shows monostatic sensing, where only one device participates in the sensing, which senses the environment by self-transmitting a sensing PPDU and self-receiving an echo signal, similarly to the operation of a conventional radar. In transmitting the sensing PPDU, the self-transmitting and self-receiving device sets an address of the transmitter and an address of the receiver of the sensing PPDU as an address of the device itself. The sensing PPDU transmitted by the device forms an echo signal through scattering and/or reflecting by the environment, and then the device can receive the echo signal by the address of the device itself, and the device can sense the environment by analyzing the echo signal. In addition, (b) of FIG. 2 shows bistatic sensing, where two devices participate in sensing, one of which transmits a sensing PPDU and the other one receives an echo signal to sense the environment. In addition, (c) of FIG. 2 shows coordinated-monostatic sensing, where more than one device participates in sensing, each device senses the environment by self-transmitting a sensing PPDU and self-receiving an echo signal, and an initiator controls all other devices to achieve coordination. In addition, (d) of FIG. 2 shows coordinated-bistatic sensing, where more than two devices participate in sensing, that is, at least two pairs of bistatic sensing devices are present, and each transmitting device (sensing transmitter) transmits a sensing PPDU and a receiving device (sensing receiver) in the same group receives a corresponding echo signal, such that the coordinated sensing is achieved. In addition, (e) of FIG. 2 shows multistatic sensing, where more than two devices participate in the sensing, one transmitting device transmits a sensing PPDU, and a plurality of receiving devices simultaneously receive echo signals and complete environment sensing.

The millimeter-wave sensing flow is described hereinafter.

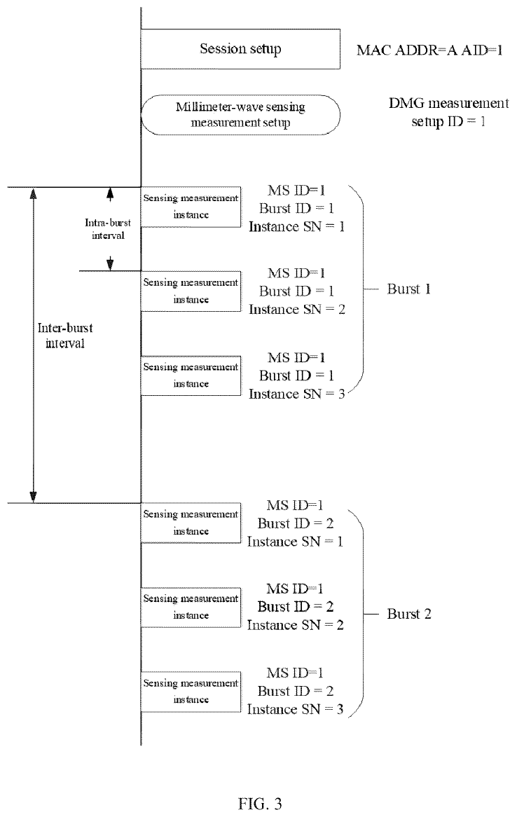

FIG. 3 is a schematic diagram of a millimeter-wave sensing flow according to some embodiments of the present disclosure. As shown in FIG. 3, the flow is a general flow of millimeter-wave sensing, where a session setup stage, a millimeter-wave sensing measurement setup (directional multi-gigabit (DMG) measurement setup) stage, and a sensing measurement stage are sequentially provided from left to right. The sensing measurement stage consists of a plurality of sensing measurement bursts, and each burst consists of a plurality of sensing measurement instances (DMG sensing instances). A time interval between bursts is an inter-burst interval, and a time interval between adjacent sensing measurement instances in one burst is an intra-burst interval. In FIG. 3, the MAC ADDR refers to a medium access control (MAC) address, the AID refers to an association identifier, the DMG measurement setup ID refers to a millimeter-wave sensing measurement setup identifier, the MS ID refers to a measurement setup (MS) identifier, the burst ID refers to a burst identifier, and the instance sequential number (SN) refers to a sensing measurement instance identifier, which may also be referred to as a sensing instance SN. The “burst” in the above description may also be referred to as an “outburst”.

The millimeter-wave coordinated-monostatic sensing measurement is described hereinafter.

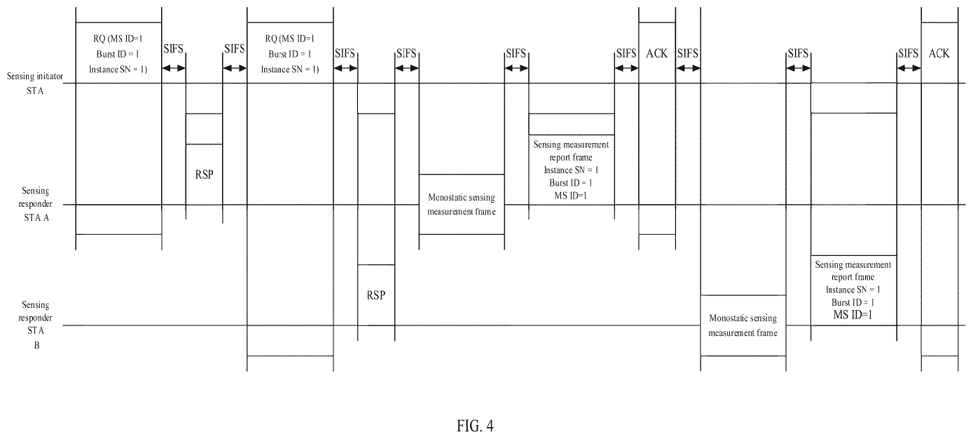

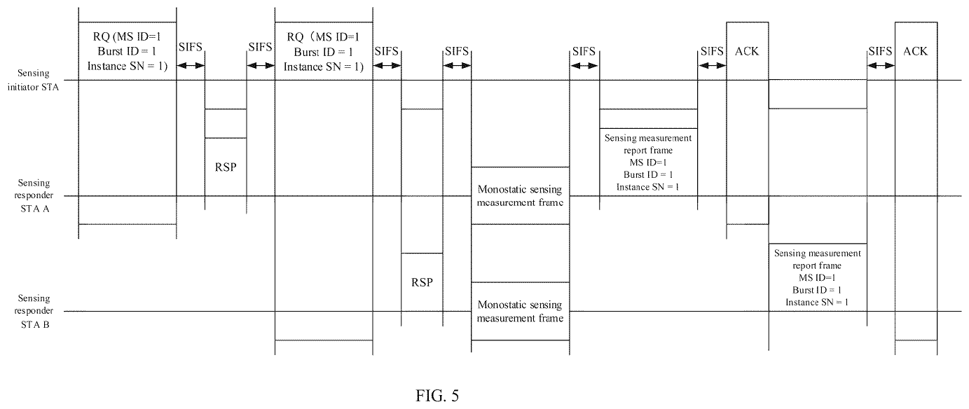

The millimeter-wave coordinated-monostatic sensing measurement has two modes, a sequential mode and a parallel mode. Exemplarily, FIG. 4 is a schematic diagram of a sequential mode of millimeter-wave coordinated-monostatic sensing measurement according to some embodiments of the present disclosure, and FIG. 5 is a schematic diagram of a parallel mode of millimeter-wave coordinated-monostatic sensing measurement according to some embodiments of the present disclosure.

As shown in FIG. 4 and FIG. 5, the sequential mode is similar to the parallel mode in that: the sensing initiator needs to transmit a DMG sensing request frame separately to each sensing responder at an initial stage of the sensing measurement instance, and each sensing responder needs to reply a DMG sensing response frame to the sensing initiator within a short interframe space (SIFS) time. The DMG sensing request may also be referred to as RQ, and the DMG sensing response may also be referred to as RSP.

As shown in FIG. 4 and FIG. 5, the sequential mode is different from the parallel mode in that: in the sequential mode, each sensing responder sequentially self-transmits and receives a monostatic sensing measurement frame (monostatic PPDU) to sense the environment, and transmits a DMG sensing measurement report frame to the sensing initiator within the SIFS time. In the parallel mode, each sensing responder simultaneously transmits and receives the monostatic sensing measurement frame to sense the environment, and then sequentially transmits the DMG sensing measurement report frame to the sensing initiator.

It should be noted that in FIG. 4 and FIG. 5, a grid above a horizontal line corresponding to the sensing initiator or the sensing responder represents a frame transmitted by the device, a grid (blank grid) below the horizontal line represents a frame received by the device, and the transmitted frame and the received frame correspond to each other. A grid centered on the horizontal line corresponding to the sensing responder represents a frame that is self-transmitted and self-received by the sensing responder, for example, a monostatic sensing measurement frame that is self-transmitted and self-received by the sensing responder. For example, in FIG. 4, the sensing initiator transmits an RQ (represented by the grid above the horizontal line corresponding to the sensing initiator) to the sensing responder STA A, and accordingly, the sensing responder STA A receives the RQ (represented by the blank grid below the horizontal line corresponding to the sensing responder STA A). Reference can be made to the above description for meanings of blank grids in other drawings of the present disclosure, which are not repeated herein.

An instance of millimeter-wave coordinated-bistatic sensing measurement is described hereinafter.

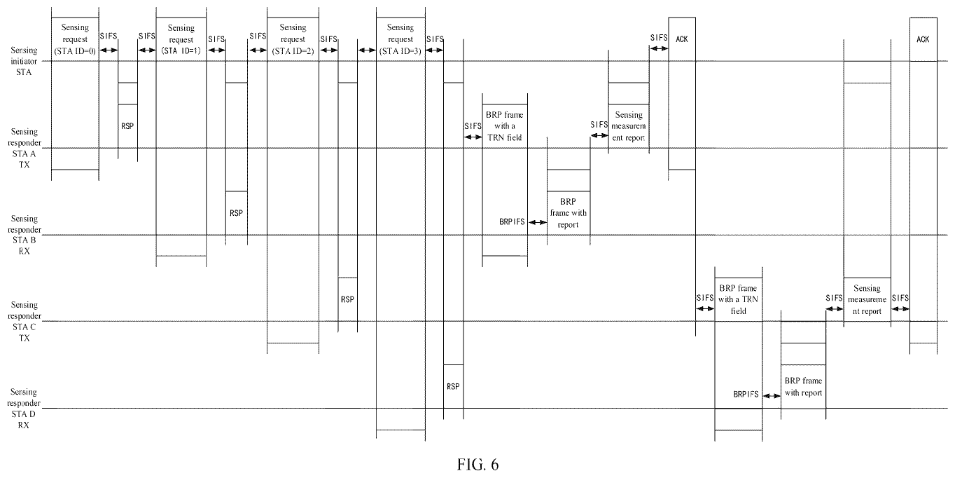

Exemplarily, FIG. 6 is a schematic diagram of millimeter-wave coordinated-bistatic sensing measurement according to some embodiments of the present disclosure. As shown in FIG. 6, the coordinated-bistatic sensing measurement involves one initiator (STA) and four responders (STA A, STA B, STA C, and STA D). The STA A and the STA C are sensing transmitters, and the STA B and the STA D are sensing receivers. The STA A transmits a beam refinement protocol (BRP) frame with a training (TRN) field (BRP frame with TRN) to the STA B, the STA B replies a BRP frame with Report to the STA A, and then the STA A transmits a DMG sensing measurement report frame to report a measurement result to the initiator. Similarly, the STA C transmits a BRP frame with a TRN field to the STA D, the STA D replies a BRP frame with Report to the STA C, and then the STA C transmits a DMG sensing measurement report frame to report a measurement result to the initiator.

A time division duplexing (TDD) beamforming frame is described hereinafter.

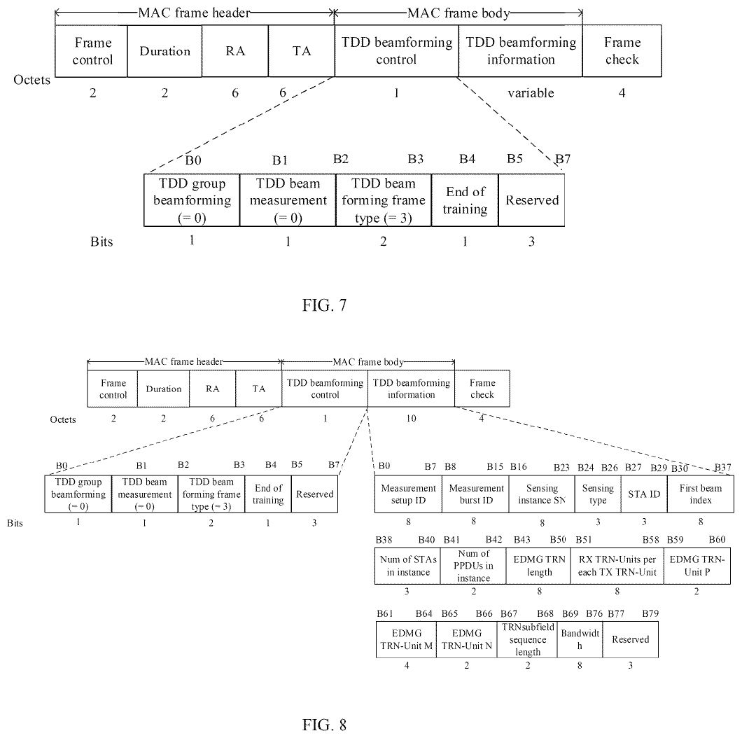

FIG. 7 is a schematic diagram of the format of a beamforming frame according to some embodiments of the present disclosure. As shown in FIG. 7, the TDD beamforming frame is a type of control frame. A MAC frame body of the TDD beamforming frame consists of two parts: a TDD beamforming control field and a TDD beamforming information field. The fields in a MAC frame header of the TDD beamforming frame have the following meanings.
Frame control indicates information such as the type of the MAC frame, including information indicating that the frame is the TDD beamforming frame.
Duration indicates the length of the transmission time of the frame.
Receiver address (RA) indicates a MAC address of the frame receiver.
Transmitter address (TA) indicates a MAC address of the frame transmitter.
TDD beamforming frame type indicates the type of the TDD beamforming frame, for which the specific values and meanings can be seen in Table 1.

TABLE 1

| Value | Meaning |
|---|---|
| 0 | TDD sector sweep (SSW) |
| 1 | TDD SSW feedback |
| 2 | TDD SSW acknowledge (Ack) |
| 3 | DMG sensing |

As shown in Table 1, the values 0, 1, and 2 of the TDD beamforming frame type field all indicate that the TDD beamforming frame is of a type related to beam training, the type is irrelevant to the methods provided in the embodiments of the present disclosure, and the value 3 indicates that the TDD beamforming frame is of a type related to DMG sensing.

In the case that the value of the TDD beamforming frame type field is 3, a TDD group beamforming field and a TDD beam measurement field jointly indicate the use of one TDD beamforming frame in DMG sensing, for which the specific values and meanings can be seen in Table 2.

TABLE 2

| TDD group | TDD beam | |
|---|---|---|
| beamforming | measurement | |
| field value | field value | Use of frame |
| 0 | 0 | DMG sensing request |
| 0 | 1 | DMG sensing response |
| 1 | 0 | DMG sensing poll |
| 1 | 1 | Reserved |

As shown in Table 2, in the case that the value of the TDD group beamforming field is 0 and the value of the TDD beam measurement field is 0, the TDD beamforming frame is indicated as the DMG sensing request frame; in the case that the value of the TDD group beamforming field is 0 and the value of the TDD beam measurement field is 1, the TDD beamforming frame is indicated as the DMG sensing response frame; and in the case that the value of the TDD group beamforming field is 1 and the value of the TDD beam measurement field is 0, the TDD beamforming frame is indicated as the DMG sensing poll frame.

The DMG sensing request frame is described hereinafter.

FIG. 8 is a schematic diagram of the format of a sensing request frame according to some embodiments of the present disclosure. As shown in FIG. 8, the fields in the TDD beamforming information field of the DMG sensing request frame have the following meanings.
Measurement setup ID refers to an identifier of a sensing measurement setup associated with the frame.
Measurement burst ID refers to an identifier of a sensing measurement burst associated with the frame.
Sensing instance sequential number (SN) indicates a sequential number of a sensing measurement instance in a measurement burst.
Sensing type indicates a sensing type requested by the frame, for which the specific values and meanings can be seen in Table 3.

TABLE 3

| Value | Meaning |
|---|---|
| 0 | Coordinated monostatic |
| 1 | Coordinated bistatic |
| 2 | Multistatic |
| 3 | Reserved |

STA ID indicates an order of a certain STA participating in the measurement in a sensing measurement instance.
First beam index indicates an index of a first transmitted beam used in a sensing measurement instance.
Num of STAs in Instance indicates a number of STAs participating in the measurement in a sensing measurement instance.
Num of PPDUs in Instance indicates a number of PPDUs occurring in a sensing measurement instance.
Enhanced directional multi-gigabit (EDMG) TRN length (EDMG TRN length) indicates a number of TRN-Units included in one PPDU.
Receive (RX) TRN-Units per transmit (TX) TRN-Unit (RX TRN-Units per each TX TRN-Unit) indicates a number of TRN-Units that are consecutively transmitted in the same direction.
EDMG TRN-Unit P indicates a number of TRN subfields of which the beam direction is aligned to an opposite-terminal device in one TRN-Unit.
EDMG TRN-Unit M indicates a number of TRN subfields of which the beam direction is variable in one TRN-Unit.
EDMG TRN-Unit N indicates a number of TRN subfields that are consecutively transmitted in the same beam direction among TRN-Unit-M of TRN subfields.
TRN subfield sequence length indicates the length of a gray sequence used by each TRN subfield.
Bandwidth indicates the bandwidth used for transmitting the TRN field.

The DMG sensing response frame is described hereinafter.

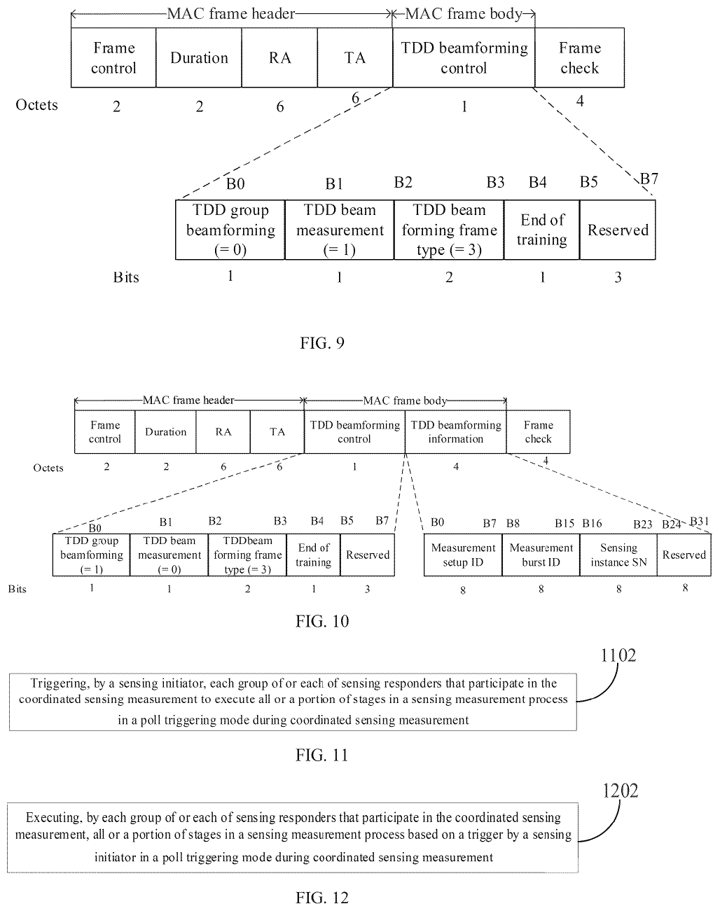

FIG. 9 is a schematic diagram of the format of a sensing response frame according to some embodiments of the present disclosure. As shown in FIG. 9, a MAC frame body of the DMG sensing response frame includes only the TDD beamforming control field.

The DMG sensing poll frame is described hereinafter.

FIG. 10 is a schematic diagram of the format of a sensing poll frame according to some embodiments of the present disclosure. As shown in FIG. 10, the fields in the TDD beamforming information field of the DMG sensing poll frame have the following meanings.
Measurement setup ID indicates an identifier of a sensing measurement setup associated with the DMG sensing poll frame.
Measurement burst ID indicates an identifier of a sensing measurement burst associated with the DMG sensing poll frame.
Sensing instance sequential number (SN) indicates an identifier of a sensing measurement instance associated with the DMG sensing poll frame.

A timing problem in the above coordinated sensing measurement is analyzed.

In the flow of the sequential mode of coordinated-monostatic sensing measurement as shown in FIG. 4, the sensing responder STA B should transmit and receive the monostatic sensing measurement frame within the SIFS time after the sensing initiator replies an acknowledge (ACK) frame to the sensing responder STA A. However, as signals are generally transmitted directionally in millimeter-wave communication (by using a beam of a narrow width), the ACK frame is directed to the sensing responder STA A instead of the sensing responder STA B, and therefore, it cannot be ensured that the STA B can receive the ACK frame, and further, it cannot be ensured that the STA B can accurately transmit the monostatic sensing measurement frame within the SIFS time after the sensing initiator transmits the ACK frame.

In addition, the duration for the sensing responder STA A to transmit and receive the monostatic sensing measurement frame and the duration to transmit the DMG sensing measurement report frame are variable. This is because the format of the monostatic sensing measurement frame is not specified at present, and any qualified PPDU (transmitting address=receiving address) can be used to implement the monostatic sensing measurement. However, a number of qualified PPDUs are present, such as a DMG control mode PPDU, a DMG single carrier (SC) mode PPDU, an EDMG control mode PPDU, an EDMG SC mode PPDU, and an EDMG orthogonal frequency division multiplexing (OFDM) mode PPDU. The duration of each PPDU is different. In addition, as the DMG sensing measurement report frame is a management frame, the DMG sensing measurement report frame may be transmitted by using different modulation and coding schemes (MCSs), such that the duration of the DMG sensing measurement report frame may also vary.

Therefore, in the above flow of the sequential mode of coordinated-monostatic sensing measurement, it is uncertain at which time the sensing responder STA B should transmit and receive the monostatic sensing measurement frame, which may result in a problem that coordinated-monostatic sensing cannot be performed normally.

In the flow of the parallel mode of coordinated-monostatic sensing measurement as shown in FIG. 5, the sensing responder STA B should transmit the DMG sensing measurement report frame to the sensing initiator within the SIFS time after the sensing initiator replies an ACK frame to the sensing responder STA A. However, the problems are still present that the sensing responder STA B cannot receive the ACK frame and the duration for the sensing responder STA A to transmit the monostatic sensing measurement frame and the duration to transmit the DMG sensing measurement report frame are variable, which result in a problem that the STA B cannot transmit its own DMG sensing measurement report frame at an accurate timing, such that the coordinated-monostatic sensing instance cannot be completed successfully.

In addition, in the flow of the coordinated-bistatic sensing measurement as shown in FIG. 6, in the case that more than one sensing transmitting device is present, a timing problem similar to that in the coordinated-monostatic sensing type described above may also occur. Specifically, the STA C needs to start transmitting the BRP frame at an SIFS time after the sensing initiator replies the ACK frame to the STA A. However, due to the narrow beam used in the millimeter-wave communication system, the signal of the ACK frame transmitted by the sensing initiator is only directed to the direction in which the STA A is located, and it is difficult to ensure that the STA C can receive the frame, such that the STA C cannot transmit the BRP frame on time, which finally affects the normal progress of the instance of coordinated-bistatic sensing measurement.

In the methods provided in the embodiments of the present disclosure, each group (coordinated-bistatic) of or each (coordinated-monostatic) of sensing responders that participate in the coordinated sensing measurement is triggered by a sensing initiator to execute all or a portion of stages in a sensing measurement process in a poll triggering mode, where the poll triggering can be implemented by one of a sensing request frame, a sensing measurement poll frame, and a sensing report poll frame, such that each of or each group of the sensing responders that participate in the coordinated sensing measurement can execute relevant stages in the sensing measurement process based on the trigger by the sensing initiator. Therefore, it is not necessary to determine a timing for starting the sensing measurement based on an ACK frame transmitted by the sensing initiator, and it is not necessary to determine whether the sensing measurement process of a previous sensing responder has ended, avoiding the problem that the coordinated sensing of a plurality of sensing devices cannot be normally performed.

FIG. 11 is a flowchart of a method for coordinated sensing measurement according to some embodiments of the present disclosure. The method is applicable to a sensing initiator, and the method includes the following step.

In step 1102: during the coordinated sensing measurement, each group of or each of sensing responders that participate in the coordinated sensing measurement is triggered by the sensing initiator to execute all or a portion of stages in a sensing measurement process in a poll triggering mode.

The coordinated sensing measurement includes a type of sequential coordinated-monostatic mode, a type of parallel coordinated-monostatic mode, and a coordinated-bistatic type. In the flow of the coordinated-monostatic sensing measurement, each of the sensing responders that participate in the coordinated sensing measurement is triggered by the sensing initiator to execute all or a portion of stages in the sensing measurement process. In the flow of the coordinated-bistatic sensing measurement, each group of the sensing responders that participate in the coordinated sensing measurement is triggered by the sensing initiator to execute all or a portion of stages in the sensing measurement process. In some embodiments, each group of the sensing responders that participate in the coordinated sensing measurement includes a sensing transmitter and a sensing receiver, and at least two groups of the sensing responders are present in the coordinated-bistatic sensing measurement.

For example, as shown in FIG. 4, the flow of the sequential mode of coordinated-monostatic sensing measurement includes a request stage, a sensing measurement stage, and a report stage. The request stage includes the steps that the sensing initiator transmits a sensing request frame to the sensing responder and the sensing responder transmits a sensing response frame to the sensing initiator, the sensing measurement stage includes the step that the sensing responder transmits a monostatic sensing measurement frame, and the report stage includes the step that the sensing responder transmits a sensing measurement report frame to the sensing initiator.

For example, as shown in FIG. 5, the flow of the parallel mode of coordinated-monostatic sensing measurement includes a request stage, a sensing measurement stage, and a report stage. The request stage includes the steps that the sensing initiator transmits a sensing request frame to the sensing responder and the sensing responder transmits a sensing response frame to the sensing initiator, the sensing measurement stage includes the step that the sensing responder transmits a monostatic sensing measurement frame, and the report stage includes the step that the sensing responder transmits a sensing measurement report frame to the sensing initiator.

For example, as shown in FIG. 6, the flow of the coordinated-bistatic sensing measurement includes a request stage, a sensing measurement stage, and a report stage. The request stage includes the steps that the sensing initiator transmits a sensing request frame to the sensing responder (including the sensing transmitter and the sensing receiver) and the sensing responder transmits a sensing response frame to the sensing initiator. The sensing measurement stage includes the steps that the sensing transmitter transmits a BRP frame with a TRN field to the sensing receiver and the sensing receiver transmits a BRP frame with Report to the sensing transmitter. The report stage includes the step that the sensing transmitter transmits a sensing measurement report frame to the sensing initiator.

In some embodiments, the poll triggering mode adopted by the sensing initiator is implemented based on at least one type of:
DMG sensing request frames;
DMG sensing measurement poll frames; or
DMG sensing report poll frames.

The sensing measurement poll frame is a trigger frame, which is configured to trigger a PPDU transmission for sensing measurement. The sensing report poll frame is a trigger frame, which is configured to trigger the report of a sensing measurement result.

In some embodiments, the sensing request frame is configured to trigger the sensing responder to execute all the stages in the sensing measurement process, the sensing measurement poll frame is configured to trigger the sensing responder to execute the sensing measurement stage and the report stage in the sensing measurement process, and the sensing report poll frame is configured to trigger the sensing responder to execute the report stage in the sensing measurement process.

In some embodiments, the sensing measurement poll frame is a trigger frame configured to trigger the sensing responder to transmit a PPDU for sensing measurement, for example, to trigger the sensing responder to transmit a monostatic sensing measurement frame. Upon receiving the sensing measurement poll frame, the sensing responder sequentially executes the sensing measurement and the report of the sensing measurement result after the sensing measurement. The sensing report poll frame is a trigger frame configured to trigger the sensing responder to report the sensing measurement result, for example, to trigger the sensing responder to transmit the sensing measurement report frame. Upon receiving the sensing report poll frame, the sensing responder reports the sensing measurement result.

In some embodiments, in the sequential mode of coordinated-monostatic sensing measurement or in the coordinated-bistatic sensing measurement, the sensing initiator triggers, through the sensing request frame, the sensing responder to execute all the stages in the sensing measurement process. In the sequential mode of coordinated-monostatic sensing measurement or in the coordinated-bistatic sensing measurement, the sensing initiator triggers, over the sensing measurement poll frame, the sensing responder to execute the sensing measurement stage and the report stage in the sensing measurement process. In the parallel mode of coordinated-monostatic sensing measurement, the sensing initiator triggers, over the sensing report poll frame, the sensing responder to execute the report stage in the sensing measurement process.

In summary, according to the method provided in the embodiments, each group of or each of sensing responders that participate in the coordinated sensing measurement is triggered by a sensing initiator to execute all or a portion of stages in a sensing measurement process in a poll triggering mode, such that each of or each group of the sensing responders that participate in the coordinated sensing measurement executes relevant stages in the sensing measurement process based on the trigger by the sensing initiator. Therefore, it is not necessary to determine a timing for starting the sensing measurement based on an ACK frame transmitted by the sensing initiator, and it is not necessary to determine whether the sensing measurement process of a previous sensing responder has ended, avoiding the problem that the coordinated sensing of a plurality of sensing devices cannot be normally performed.

FIG. 12 is a flowchart of a method for coordinated sensing measurement according to some embodiments of the present disclosure. The method is applicable to a sensing responder, and the method includes the following steps.

In step 1202: during the coordinated sensing measurement, all or a portion of stages in a sensing measurement process are executed by each group of or each of the sensing responders that participate in the coordinated sensing measurement based on a trigger by a sensing initiator in a poll triggering mode.

The coordinated sensing measurement includes a type of sequential coordinated-monostatic mode, a type of parallel coordinated-monostatic mode, and a coordinated-bistatic type. In the flow of the coordinated-monostatic sensing measurement, each of the sensing responders that participate in the coordinated sensing measurement is triggered by the sensing initiator to execute all or a portion of stages in the sensing measurement process. In the flow of the coordinated-bistatic sensing measurement, each group of sensing responders that participate in the coordinated sensing measurement is triggered by the sensing initiator to execute all or a portion of stages in the sensing measurement process. In some embodiments, each group of the sensing responders that participate in the coordinated sensing measurement includes a sensing transmitter and a sensing receiver, and at least two groups of the sensing responders are present in the coordinated-bistatic sensing measurement.

Exemplarily, in the flow of the sequential mode of coordinated-monostatic sensing measurement, the request stage includes the steps that the sensing initiator transmits a sensing request frame to the sensing responder and the sensing responder transmits a sensing response frame to the sensing initiator, the sensing measurement stage includes the step that the sensing responder transmits a monostatic sensing measurement frame, and the report stage includes the step that the sensing responder transmits a sensing measurement report frame to the sensing initiator. In the flow of the parallel mode of coordinated-monostatic sensing measurement, the request stage includes the steps that the sensing initiator transmits a sensing request frame to the sensing responder and the sensing responder transmits a sensing response frame to the sensing initiator, the sensing measurement stage includes the step that the sensing responder transmits a monostatic sensing measurement frame, and the report stage includes the step that the sensing responder transmits a sensing measurement report frame to the sensing initiator. In the flow of the coordinated-bistatic sensing measurement, the request stage includes the steps that the sensing initiator transmits a sensing request frame to the sensing responder and the sensing responder transmits a sensing response frame to the sensing initiator. The sensing measurement stage includes the steps that the sensing transmitter transmits a BRP frame with a TRN field to the sensing receiver and the sensing receiver transmits a BRP frame with Report to the sensing transmitter. The report stage includes the step that the sensing transmitter transmits a sensing measurement report frame to the sensing initiator.

In some embodiments, the poll triggering mode adopted by the sensing initiator is implemented based on at least one type of:
sensing request frames;
sensing measurement poll frames; or
sensing report poll frames.

The sensing measurement poll frame is a trigger frame, which is configured to trigger a PPDU transmission for sensing measurement. The sensing report poll frame is a trigger frame, which is configured to trigger the report of a sensing measurement result. In some embodiments, the sensing request frame is configured to trigger the sensing responder to execute all the stages in the sensing measurement process, the sensing measurement poll frame is configured to trigger the sensing responder to execute the sensing measurement stage and the report stage in the sensing measurement process, and the sensing report poll frame is configured to trigger the sensing responder to execute the report stage in the sensing measurement process.

In some embodiments, the sensing measurement poll frame is a trigger frame configured to trigger the sensing responder to transmit a PPDU for sensing measurement, for example, to trigger the sensing responder to transmit a monostatic sensing measurement frame. Upon receiving the sensing measurement poll frame, the sensing responder sequentially executes the sensing measurement and the report of the sensing measurement result after the sensing measurement. The sensing report poll frame is a trigger frame configured to trigger the sensing responder to report the sensing measurement result, for example, to trigger the sensing responder to transmit the sensing measurement report frame. Upon receiving the sensing report poll frame, the sensing responder reports the sensing measurement result.

In some embodiments, in the sequential mode of coordinated-monostatic sensing measurement or in the coordinated-bistatic sensing measurement, the sensing initiator triggers, through the sensing request frame, the sensing responder to execute all the stages in the sensing measurement process. In the sequential mode of coordinated-monostatic sensing measurement or in the coordinated-bistatic sensing measurement, the sensing initiator triggers, over the sensing measurement poll frame, the sensing responder to execute the sensing measurement stage and the report stage in the sensing measurement process. In the parallel mode of coordinated-monostatic sensing measurement, the sensing initiator triggers, over the sensing report poll frame, the sensing responder to execute the report stage in the sensing measurement process.

In summary, according to the method provided in the embodiments, each group of or each of sensing responders that participate in the coordinated sensing measurement is triggered by a sensing initiator to execute all or a portion of stages in a sensing measurement process in a poll triggering mode, such that each of or each group of the sensing responders that participate in the coordinated sensing measurement executes relevant stages in the sensing measurement process based on the trigger by the sensing initiator. Therefore, it is not necessary to determine a timing for starting the sensing measurement based on an ACK frame transmitted by the sensing initiator, and it is not necessary to determine whether the sensing measurement process of a previous sensing responder has ended, avoiding the problem that the coordinated sensing of a plurality of sensing devices cannot be normally performed.

According to the method provided in the embodiments of the present disclosure, each group of or each of sensing responders that participate in the coordinated sensing measurement is triggered by a sensing initiator to execute all or a portion of stages in a sensing measurement process in a poll triggering mode, such that each of or each group of the sensing responders that participate in the coordinated sensing measurement executes relevant stages in the sensing measurement process based on the trigger by the sensing initiator, avoiding the problem that the coordinated sensing of a plurality of sensing devices cannot be normally performed. In some embodiments, the poll triggering mode adopted by the sensing initiator is implemented based on at least one type of:
sensing request frames;
sensing measurement poll frames; or
sensing report poll frames.

The above 3 frame formats are described hereinafter.

For description of the sensing measurement poll frame:

In the embodiments of the present disclosure, the following two solutions are present for the design of the sensing measurement poll frame.

### (1) The Sensing Measurement Poll Frame is Newly Defined.

In this solution, the sensing measurement poll frame is a kind of TDD beamforming frame, which is not any type of sensing request frame, sensing response frame, or sensing poll frame in the TDD beamforming frame.

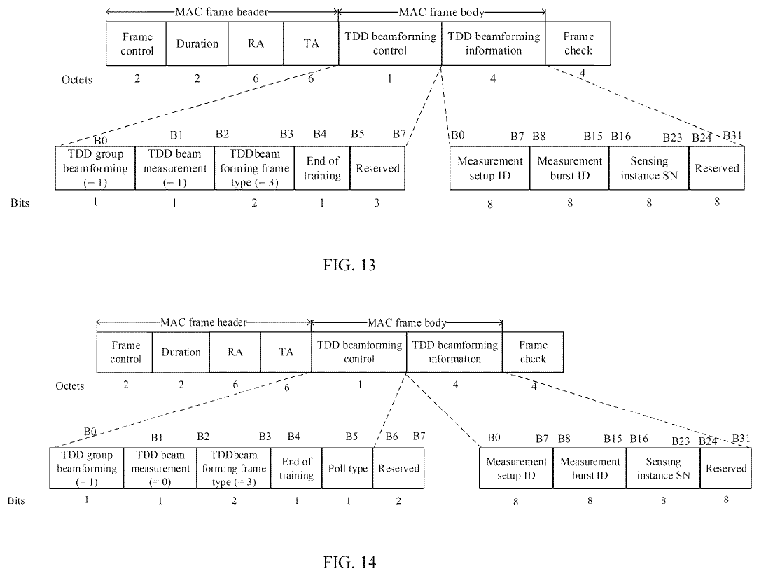

Exemplarily, FIG. 13 is a schematic diagram of a format of a sensing measurement poll frame according to some embodiments of the present disclosure. As shown in FIG. 13, the fields in a MAC frame header of the sensing measurement poll frame (TDD beamforming frame) have the following meanings.
Frame control indicates information such as the type of the MAC frame, including information indicating that the frame is the TDD beamforming frame.
Duration indicates the length of the transmission time of the frame.
TA indicates a MAC address of the frame transmitter.
RA indicates a MAC address of the frame receiver.

A MAC frame body of the TDD beamforming frame includes a TDD beamforming control field, and the TDD beamforming control field includes a TDD group beamforming field and a TDD beam measurement field. The fields in the MAC frame body of the sensing measurement poll frame (TDD beamforming frame) have the following meanings.
TDD group beamforming and TDD beam measurement jointly indicate the use of one TDD beamforming frame, for which the specific values and meanings can be seen in Table 4.

TABLE 4

| TDD group | TDD beam | |
|---|---|---|
| beamforming | measurement | |
| field value | field value | Use of frame |
| 0 | 0 | DMG sensing request |
| 0 | 1 | DMG sensing response |
| 1 | 0 | DMG sensing poll |
| 1 | 1 | DMG sensing measurement poll |

As shown in Table 4, in the case that the value of the TDD group beamforming field is 0 and the value of the TDD beam measurement field is 0, the TDD beamforming frame is indicated as the sensing request frame; in the case that the value of the TDD group beamforming field is 0 and the value of the TDD beam measurement field is 1, the TDD beamforming frame is indicated as the sensing response frame; and in the case that the value of the TDD group beamforming field is 1 and the value of the TDD beam measurement field is 0, the TDD beamforming frame is indicated as the sensing poll frame. In the case that the value of the TDD group beamforming field is 1 and the value of the TDD beam measurement field is 1, the TDD beamforming frame is indicated as the sensing measurement poll frame.
TDD beamforming frame type indicates the type of the TDD beamforming frame, where the value of 3 indicates that the frame is a TDD beamforming frame for DMG sensing.
End of training indicates whether the beam training has ended.
Measurement setup ID indicates an identifier of a sensing measurement setup associated with the sensing measurement poll frame.
Measurement burst ID indicates an identifier of a sensing measurement burst associated with the sensing measurement poll frame.
Sensing instance sequential number (SN) indicates an identifier of a sensing measurement instance associated with the sensing measurement poll frame.

### (2) The Sensing Measurement Poll Frame is Acquired by Modification Based on an Existing Sensing Poll Frame.

In this solution, the sensing measurement poll frame is a DMG sensing poll frame with a poll type field added in a TDD beamforming control field in a MAC frame body, and the poll type field indicates that the sensing poll frame added with the poll type field is the sensing measurement poll frame. In some embodiments, the sensing poll frame is defined in the IEEE 802.11bf D0.1 standard.

Exemplarily, FIG. 14 is a schematic diagram of a format of a sensing measurement poll frame according to some embodiments of the present disclosure. As shown in FIG. 14, reference can be made to the newly defined sensing measurement poll frame as described above for the meanings of the fields in the MAC frame header of the sensing measurement poll frame (the sensing poll frame added with the poll type field), which are not repeated in the embodiments of the present disclosure. The values of the TDD group beamforming field and the TDD beam measurement field in the MAC frame body of the sensing measurement poll frame are 1 and 0, separately, and the value of TDD beamforming frame type is 3, which indicates that the frame is a sensing poll frame in the TDD beamforming frame for DMG sensing.

Poll type indicates the type of the sensing poll frame, for which the specific values and meanings can be seen in Table 5.

TABLE 5

| Value | Meaning |
|---|---|
| 0 | DMG sensing report poll |
| 1 | DMG sensing measurement poll |

As shown in Table 5, in the case that the value of the poll type field is 1, the sensing poll frame added with the poll type field is the sensing measurement poll frame. In the case that the value of the poll type field is 0, the sensing poll frame added with the poll type field is the sensing report poll frame.

The DMG sensing report poll indicates that the trigger frame is configured to trigger the report of the sensing measurement result, and the DMG sensing measurement poll indicates that the trigger frame is configured to trigger a PPDU transmission for sensing measurement. The only difference between the two trigger frames in terms of frame format is that the value of the “poll type” field is different, with all the other fields and meanings thereof being the same.

It should be noted that the above values are only used as examples, and are not used as limitations to the method provided in the embodiments of the present disclosure. For example, in the case that the value of the poll type field is 0, the sensing poll frame added with the poll type field is the sensing measurement poll frame. In the case that the value of the poll type field is 1, the sensing poll frame added with the poll type field is the sensing report poll frame. That is, in the case that the value of the poll type field is 0 or 1, all the sensing poll frames added with the poll type field may be sensing measurement poll frames. However, the poll type fields of the sensing measurement poll frame and the sensing report poll frame have different values. For example, the value of the poll type field of the sensing measurement poll frame may be 2, and the value of the poll type field of the sensing report poll frame may be 3. Moreover, the name “poll type” is merely used as an example, and other names may be used instead.

It should be noted that in the use of the sensing measurement poll frame in the solution provided in the embodiments of the present disclosure, the use methods of the two frame formats of the sensing measurement poll frame are the same.

### For Description of the Sensing Report Poll Frame:

For the sensing report poll frame, reference can be made to the above description of acquiring the sensing measurement poll frame by modification based on the existing sensing poll frame. Exemplarily, the sensing report poll frame is a sensing poll frame with a poll type field added in a TDD beamforming control field in a MAC frame body, and the poll type field indicates that the sensing poll frame added with the poll type field is the sensing report poll frame. Similar to the above description, in the case that the value of the poll type field is 0 or 1, all the sensing poll frames added with the poll type field may be sensing report poll frames. However, it is required to ensure that the poll type fields of the sensing measurement poll frame and the sensing report poll frame have different values.

### For Description of the Sensing Request Frame:

For the description of the sensing request frame, reference can be made to relevant contents in FIG. 8 and Table 3, which are not repeated in the embodiments of the present disclosure. In the solution using the sensing request frame, the method provided in the embodiments of the present disclosure is mainly different from the related art in that the method provided in the embodiments of the present disclosure triggers, through the sensing request frame, each (group) of sensing responders to execute the whole sensing measurement process, such that the above timing problem can be solved. For a detailed description of the solution using the sensing request frame, reference can be made to the following embodiments.

### The Design of the Flow of a Sensing Measurement Instance Implemented Based on the Above 3 Frames is Described Hereinafter.

The sensing initiator can trigger, through one of the above 3 frames, each group of or each of the sensing responders that participate in the coordinated sensing measurement to execute all or a portion of stages in the sensing measurement process, which can be specifically divided into the following 8 cases.
(1) In the sequential mode of coordinated-monostatic sensing measurement, each sensing executor is triggered by the sensing measurement poll frame to execute the sensing measurement stage and the report stage in the sensing measurement process.
(2) In the sequential mode of coordinated-monostatic sensing measurement, each sensing executor except a first sensing executor is triggered by the sensing measurement poll frame to execute the sensing measurement stage and the report stage in the sensing measurement process.
(3) In the sequential mode of coordinated-monostatic sensing measurement, each sensing executor is triggered by the sensing request frame to execute all the stages in the sensing measurement process.
(4) In the parallel mode of coordinated-monostatic sensing measurement, each sensing executor is triggered by the sensing report poll frame to execute the report stage in the sensing measurement process.
(5) In the parallel mode of coordinated-monostatic sensing measurement, each sensing executor except a first sensing executor is triggered by the sensing report poll frame to execute the report stage in the sensing measurement process.
(6) In the coordinated-bistatic sensing measurement, each group of the sensing executors is triggered by the sensing measurement poll frame to execute the sensing measurement stage and the report stage in the sensing measurement process.
(7) In the coordinated-bistatic sensing measurement, each group of the sensing executors except a first group of the sensing executors is triggered by the sensing measurement poll frame to execute the sensing measurement stage and the report stage in the sensing measurement process.
(8) In the coordinated-bistatic sensing measurement, each group of the sensing executors is triggered by the sensing request frame to execute all the stages in the sensing measurement process.

The above solutions are described hereinafter with reference to 8 embodiments.

### For the First Case Described Above:

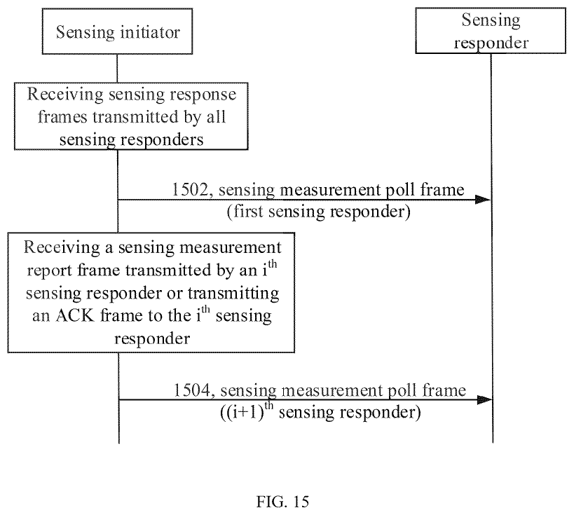

FIG. 15 is a flowchart of a method for coordinated sensing measurement according to some embodiments of the present disclosure. The method is applicable to the system as shown in FIG. 1, and the method includes the following steps.

In step 1502: the sensing initiator transmits the sensing measurement poll frame to a first sensing responder upon receiving sensing response frames transmitted by all the sensing responders.

The type of the coordinated sensing measurement in the embodiments is a sequential coordinated-monostatic mode, and each sensing responder corresponds to one sensing measurement poll frame. The sensing measurement poll frame is configured to trigger the sensing responder to transmit a monostatic sensing measurement frame.

Upon receiving the sensing measurement poll frame, the first sensing responder self-transmits and receives the monostatic sensing measurement frame to sense the environment, and transmits the sensing measurement report frame to the sensing initiator.

In some embodiments, a difference of an SIFS time is present between the sensing response frame corresponding to a last sensing responder and the sensing measurement poll frame corresponding to the first sensing responder.

In step 1504: the sensing initiator transmits the sensing measurement poll frame to an (i+1)^{th} sensing responder upon receiving a sensing measurement report frame transmitted by an i^{th} sensing responder or transmitting an ACK frame to the i^{th} sensing responder.

In some embodiments, the sensing initiator transmits or does not transmit the ACK frame to the i^{th} sensing responder.

In the case that the ACK frame is transmitted, the sensing initiator transmits the sensing measurement poll frame to the (i+1)^{th} sensing responder upon transmitting the ACK frame to the i^{th} sensing responder. In the case that the ACK frame is not transmitted, the sensing initiator transmits the sensing measurement poll frame to the (i+1)^{th} sensing responder upon receiving the sensing measurement report frame transmitted by the i^{th} sensing responder.

In some embodiments, a difference of an SIFS time is present between the sensing measurement report frame corresponding to the i^{th} sensing responder or the ACK frame corresponding to the i^{th} sensing responder and the sensing measurement poll frame corresponding to the (i+1)^{th} sensing responder.

Upon receiving the sensing measurement poll frame, the (i+1)^{th} sensing responder self-transmits and receives the monostatic sensing measurement frame to sense the environment, and transmits the sensing measurement report frame to the sensing responder. Here, i is a positive integer.

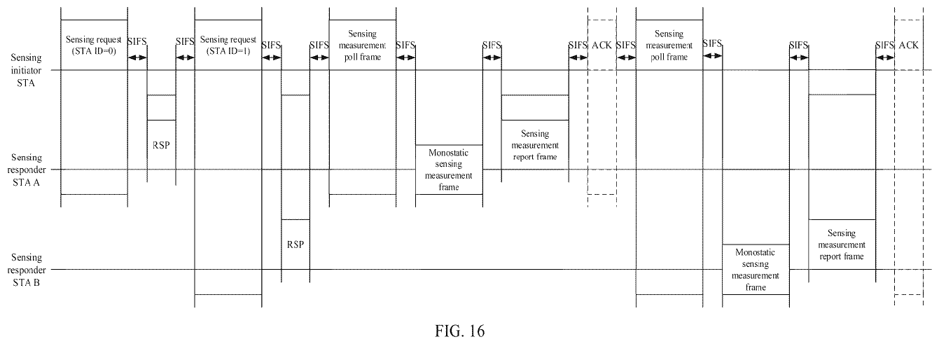

In a specific example, FIG. 16 is a schematic flowchart of a sequential mode of coordinated-monostatic sensing measurement according to some embodiments of the present disclosure. As shown in FIG. 16, the flow involves one initiator (STA) and two responders (STA A and STA B), and the flow includes the following processes (from left to right).
(1) The initiator transmits a DMG sensing request frame to the STA A, where “Num of STAs in instance”=2, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) After the SIFS time, the initiator transmits a DMG sensing measurement poll frame to the STA A to trigger the STA A to start the sensing measurement.
(6) After the SIFS time, the STA A self-transmits and self-receives a monostatic sensing measurement frame to sense the environment.
(7) After the SIFS time, the STA A transmits a DMG sensing measurement report frame to the initiator to report a sensing measurement result.
(8) After the SIFS time, the initiator replies an ACK frame to the STA A.
(9) After the SIFS time, the initiator transmits a DMG sensing measurement poll frame to the STA B to trigger the STA B to start the sensing measurement.
(10) After the SIFS time, the STA B self-transmits and self-receives a monostatic sensing measurement frame to sense the environment.
(11) After the SIFS time, the STA B transmits a DMG sensing measurement report frame to the initiator to report a sensing measurement result.
(12) After the SIFS time, the initiator replies an ACK frame to the STA B.

It should be noted that (8) and (12) above are optional steps. In the above example, only 2 responders are present, and in the case that more responders are present, subsequent responders can be triggered to transmit the monostatic sensing measurement frame continuously by using the above method. The above DMG sensing measurement report frame is in the format shown in FIG. 13 or in the format shown in FIG. 14. Compared with the flow shown in FIG. 4, the difference is that the initiator needs to sequentially transmit the DMG sensing measurement poll frame to each responder to trigger the responder to transmit and receive the monostatic sensing measurement frame, and that each responder starts self-transmitting and self-receiving the monostatic sensing measurement frame within the SIFS time upon receiving the DMG sensing measurement poll frame, with other flows being the same.

In summary, according to the method provided in the embodiments, each sensing responder that participates in the coordinated sensing measurement is triggered by the sensing initiator over the sensing measurement poll frame to execute the measurement stage and the report stage in the sensing measurement process, such that the time at which each sensing responder transmits and receives the monostatic sensing measurement frame is only related to the time when the sensing responder receives the sensing measurement poll frame, but is not related to the duration and time when other sensing responders transmit and receive the monostatic sensing measurement frame, avoiding the problem that the coordinated sensing of a plurality of sensing devices cannot be normally performed. In addition, the sensing initiator directionally transmits the sensing measurement poll frame to each sensing responder, ensuring that each sensing responder receives the trigger signal reliably.

### For the Second Case Described Above:

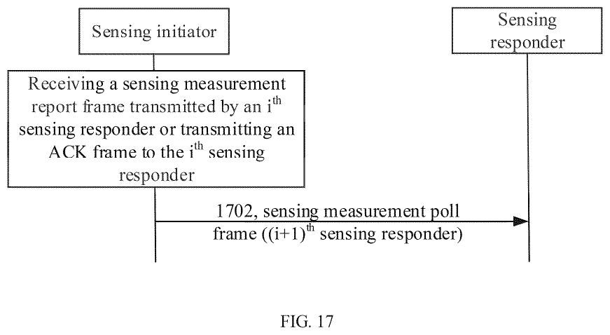

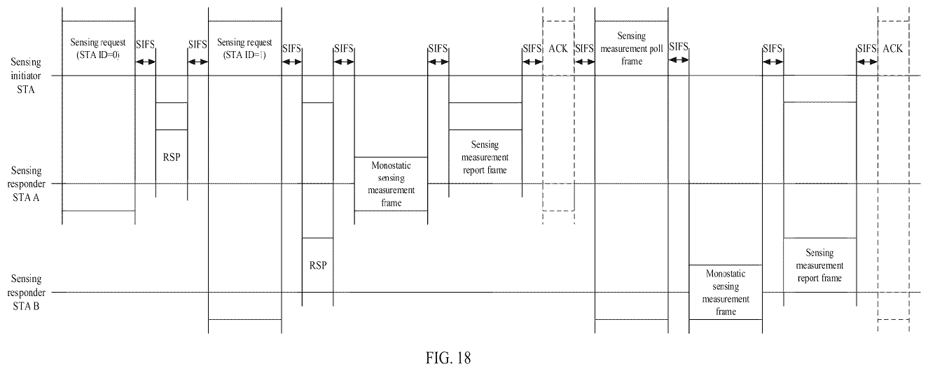

FIG. 17 is a flowchart of a method for coordinated sensing measurement according to some embodiments of the present disclosure. The method is applicable to the system as shown in FIG. 1, and the method includes the following step.

In step 1702: the sensing initiator transmits the sensing measurement poll frame to an (i+1)^{th} sensing responder upon receiving a sensing measurement report frame transmitted by an i^{th} sensing responder or transmitting an ACK frame to the i^{th} sensing responder.

The type of the coordinated sensing measurement in the embodiments is a sequential coordinated-monostatic mode, and each sensing responder except a first sensing responder corresponds to one sensing measurement poll frame. The sensing measurement poll frame is configured to trigger the sensing responder to transmit a monostatic sensing measurement frame. Here, i is a positive integer.

After all the sensing responders receive the sensing request frame transmitted by the sensing initiator and reply with the sensing response frame, the first sensing responder self-transmits and receives the monostatic sensing measurement frame to sense the environment, and transmits the sensing measurement report frame to the sensing initiator.

In some embodiments, the sensing initiator transmits or does not transmit the ACK frame to the i^{th} sensing responder.

In the case that the ACK frame is transmitted, the sensing initiator transmits the sensing measurement poll frame to the (i+1)^{th} sensing responder upon transmitting the ACK frame to the i^{th} sensing responder. In the case that the ACK frame is not transmitted, the sensing initiator transmits the sensing measurement poll frame to the (i+1)^{th} sensing responder upon receiving the sensing measurement report frame transmitted by the i^{th} sensing responder.

Upon receiving the sensing measurement poll frame, the (i+1)^{th} sensing responder self-transmits and receives the monostatic sensing measurement frame to sense the environment, and transmits the sensing measurement report frame to the sensing responder.

In some embodiments, a difference of an SIFS time is present between the sensing measurement report frame corresponding to the i^{th} sensing responder or the ACK frame corresponding to the i^{th} sensing responder and the sensing measurement poll frame corresponding to the (i+1)^{th} sensing responder.

In a specific example, FIG. 18 is a schematic flowchart of a sequential mode of coordinated-monostatic sensing measurement according to some embodiments of the present disclosure. As shown in FIG. 18, the flow involves one initiator (STA) and two responders (STA A and STA B), and the flow includes the following processes (from left to right).
(1) The initiator transmits a DMG sensing request frame to the STA A, where “Num of STAs in instance”=2, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) After the SIFS time, the STA A self-transmits and self-receives a monostatic sensing measurement frame to sense the environment.
(6) After the SIFS time, the STA A transmits a DMG sensing measurement report frame to the initiator to report a sensing measurement result.
(7) After the SIFS time, the initiator replies an ACK frame to the STA A.
(8) After the SIFS time, the initiator transmits a DMG sensing measurement poll frame to the STA B to trigger the STA B to start the sensing measurement.
(9) After the SIFS time, the STA B self-transmits and self-receives a monostatic sensing measurement frame to sense the environment.
(10) After the SIFS time, the STA B transmits a DMG sensing measurement report frame to the initiator to report a sensing measurement result.
(11) After the SIFS time, the initiator replies an ACK frame to the STA B.

It should be noted that (7) and (11) above are optional steps. In the above example, only 2 responders are present, and in the case that more responders are present, subsequent responders can be triggered to transmit the monostatic sensing measurement frame continuously by using the above method. The above DMG sensing measurement report frame is in the format shown in FIG. 13 or in the format shown in FIG. 14. Compared with the flow shown in FIG. 16, the difference is that after the SIFS time since the last responder (STA B) replies the DMG sensing response frame to the initiator, the first responder (STA A) actively starts self-transmitting and self-receiving the monostatic sensing measurement frame to sense the environment, without waiting for the initiator to transmit the DMG sensing measurement poll frame, with other flows being the same.

In summary, according to the method provided in the embodiments, each sensing responder that participates in the coordinated sensing measurement after a first sensing responder is triggered by the sensing initiator through the sensing measurement poll frame to execute the measurement stage and the report stage in the sensing measurement process, such that the time at which each sensing responder except the first sensing responder transmits and receives the monostatic sensing measurement frame is only related to the time at which the sensing responder receives the sensing measurement poll frame, but is not related to the times at which other sensing responders transmit and receive the monostatic sensing measurement frame, avoiding the problem that the coordinated sensing of a plurality of sensing devices cannot be normally performed. In addition, the sensing initiator directionally transmits the sensing measurement poll frame to each sensing responder except the first sensing responder, ensuring that each sensing responder except the first sensing responder receives the trigger signal reliably.

### For the Third Case Described Above:

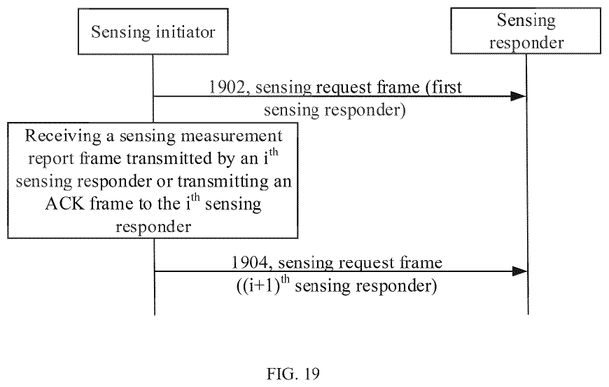

FIG. 19 is a flowchart of a method for coordinated sensing measurement according to some embodiments of the present disclosure. The method is applicable to the system as shown in FIG. 1, and the method includes the following steps.

In step 1902: the sensing initiator transmits the sensing request frame to a first sensing responder.

The type of the coordinated sensing measurement in the embodiments is a sequential coordinated-monostatic mode, and each sensing responder corresponds to one sensing request frame. The sensing request frame is configured to trigger one sensing responder to execute all the stages in the sensing measurement process.

Upon receiving the sensing request frame, the first sensing responder transmits the sensing response frame to the sensing initiator, and then self-transmits and receives the monostatic sensing measurement frame to sense the environment, and transmits the sensing measurement report frame to the sensing responder.

In step 1904: the sensing initiator transmits the sensing request frame to an (i+1)^{th} sensing responder upon receiving a sensing measurement report frame transmitted by an i^{th} sensing responder or transmitting an ACK frame to the i^{th} sensing responder.

In some embodiments, the sensing initiator transmits or does not transmit the ACK frame to the i^{th} sensing responder.

In the case that the ACK frame is transmitted, the sensing initiator transmits the sensing request frame to the (i+1)^{th} sensing responder upon transmitting the ACK frame to the i^{th} sensing responder. In the case that the ACK frame is not transmitted, the sensing initiator transmits the sensing measurement poll frame to the (i+1)^{th} sensing responder upon receiving the sensing measurement report frame transmitted by the i^{th} sensing responder.

Upon receiving the sensing request frame, the (i+1)^{th} sensing responder transmits the sensing response frame to the sensing initiator, and then self-transmits and receives the monostatic sensing measurement frame to sense the environment, and transmits the sensing measurement report frame to the sensing responder. Here, i is a positive integer.

In some embodiments, a difference of an SIFS time is present between the sensing measurement report frame corresponding to the i^{th} sensing responder or the ACK frame corresponding to the i^{th} sensing responder and the sensing request frame corresponding to the (i+1)^{th} sensing responder.

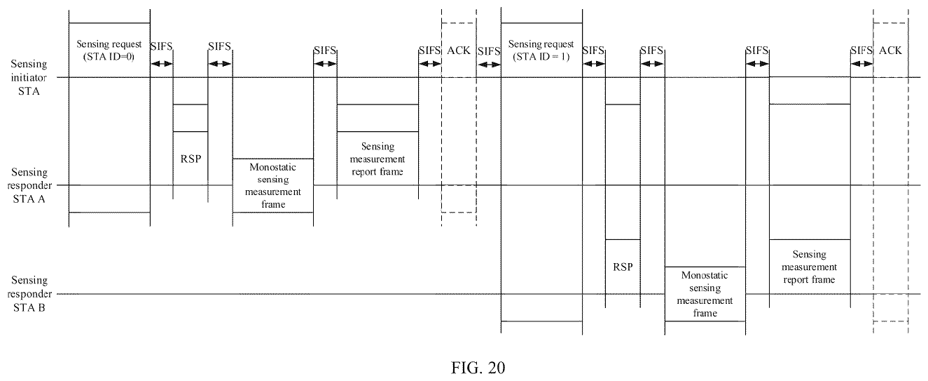

In a specific example, FIG. 20 is a schematic flowchart of a sequential mode of coordinated-monostatic sensing measurement according to some embodiments of the present disclosure. As shown in FIG. 20, the flow involves one initiator (STA) and two responders (STA A and STA B), and the flow includes the following processes (from left to right).
(1) The initiator first transmits a DMG sensing request frame to the STA A, where “Num of STAs in instance”=2, “Num of PPDUs”=1, and “STA ID”=0 are set.
(2) After the SIFS time, the STA A replies a DMG sensing response frame to the initiator.
(3) After the SIFS time, the STA A self-transmits and self-receives a monostatic sensing measurement frame to sense the environment.
(4) After the SIFS time, the STA A transmits a DMG sensing measurement report frame to the initiator to report a sensing measurement result.
(5) After the SIFS time, the initiator replies an ACK frame to the STA A.
(6) After the SIFS time, the initiator then transmits a DMG sensing request frame to the STA B, where “Num of STAs in instance”=2, “Num of PPDUs”=1, and “STA ID”=1 are set.
(7) After the SIFS time, the STA B replies a DMG sensing response frame to the initiator.
(8) After the SIFS time, the STA B self-transmits and self-receives a monostatic sensing measurement frame to sense the environment.
(9) After the SIFS time, the STA B transmits a DMG sensing measurement report frame to the initiator to report a sensing measurement result.
(10) After the SIFS time, the initiator replies an ACK frame to the STA B.

It should be noted that (5) and (10) above are optional steps. In the above example, only 2 responders are present, and in the case that more responders are present, subsequent responders can be triggered to execute the whole sensing measurement process by using the above method. The above DMG sensing request frame is in the format shown in FIG. 8. Compared with the flow shown in FIG. 4, the difference is that the initiator starts exchanging with the STA B upon exchanging all frames with the STA A. That is, after the responder executes the whole sensing measurement process, the initiator triggers, through the DMG sensing request frame, a next responder to execute the whole sensing measurement process.

In summary, according to the method provided in the embodiments, each sensing responder that participates in the coordinated sensing measurement is triggered by the sensing initiator over the sensing request frame to execute the whole sensing measurement process, such that the time at which each sensing responder starts executing the sensing measurement process is only related to the time at which the sensing responder receives the sensing request frame, avoiding the problem that the coordinated sensing of a plurality of sensing devices cannot be normally performed.

### For the Fourth Case Described Above:

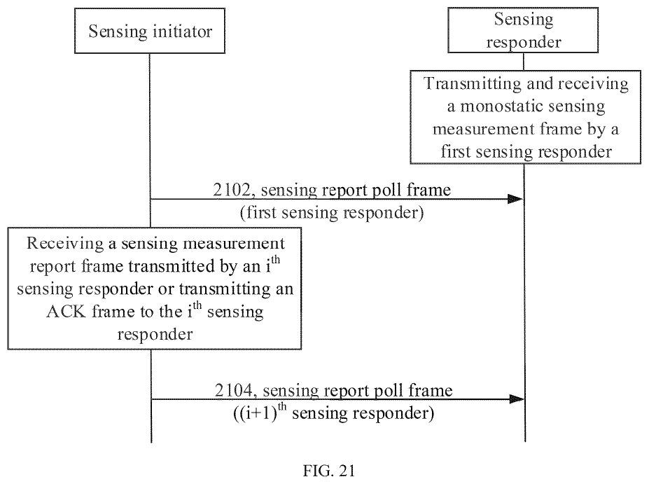

FIG. 21 is a flowchart of a method for coordinated sensing measurement according to some embodiments of the present disclosure. The method is applicable to the system as shown in FIG. 1, and the method includes the following steps.

In step 2102: the sensing initiator transmits the sensing report poll frame to a first sensing responder after the first sensing responder transmits and receives a monostatic sensing measurement frame.

The type of the coordinated sensing measurement in the embodiments is a parallel coordinated-monostatic mode, and each sensing responder corresponds to one sensing report poll frame. The sensing report poll frame is configured to trigger the sensing responder to transmit the sensing measurement report frame.

Upon receiving the sensing report poll frame, the first sensing responder transmits the sensing measurement report frame to the sensing initiator. Before this, the first sensing responder has self-transmitted and received the monostatic sensing measurement frame to sense the environment.

Exemplarily, in the parallel coordinated-monostatic mode, different sensing responders simultaneously self-transmit and receive the monostatic sensing measurement frame to sense the environment.

In some embodiments, a difference of an SIFS time is present between the monostatic sensing measurement frame corresponding to the first sensing responder and the sensing report poll frame corresponding to the first sensing responder.

In step 2104: the sensing initiator transmits the sensing report poll frame to an (i+1)^{th} sensing responder upon receiving a sensing measurement report frame transmitted by an i^{th} sensing responder or transmitting an ACK frame to the i^{th} sensing responder.

In some embodiments, the sensing initiator transmits or does not transmit the ACK frame to the i^{th} sensing responder.

In the case that the ACK frame is transmitted, the sensing initiator transmits the sensing report poll frame to the (i+1)^{th} sensing responder upon transmitting the ACK frame to the i^{th} sensing responder. In the case that the ACK frame is not transmitted, the sensing initiator transmits the sensing report poll frame to the (i+1)^{th} sensing responder upon receiving the sensing measurement report frame transmitted by the i^{th} sensing responder.

Upon receiving the sensing report poll frame, the (i+1)^{th} sensing responder transmits the sensing measurement report frame to the sensing responder. Here, i is a positive integer.

In some embodiments, a difference of an SIFS time is present between the sensing measurement report frame corresponding to the i^{th} sensing responder or the ACK frame corresponding to the i^{th} sensing responder and the sensing report poll frame corresponding to the (i+1)^{th} sensing responder.

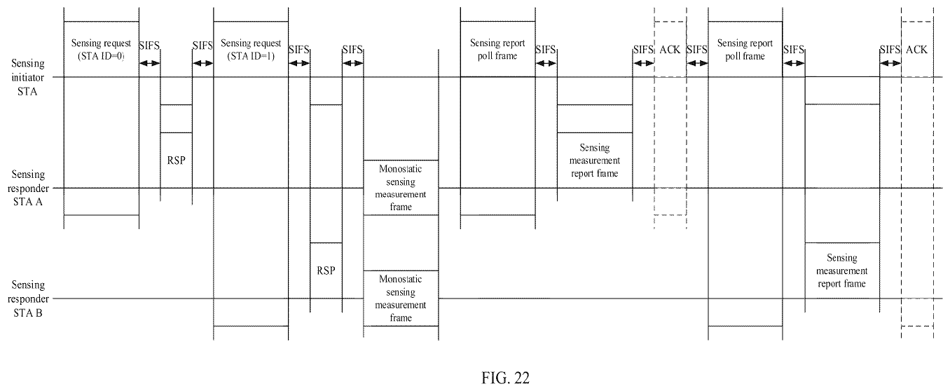

In a specific example, FIG. 22 is a schematic flowchart of a parallel mode of coordinated-monostatic sensing measurement according to some embodiments of the present disclosure. As shown in FIG. 22, the flow involves one initiator (STA) and two responders (STA A and STA B), and the flow includes the following processes (from left to right).
(1) The initiator transmits a DMG sensing request frame to the STA A, where “Num of STAs in instance”=2, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) After the SIFS time, the STA A and the STA B separately self-transmit and self-receive a monostatic sensing measurement frame simultaneously to sense the environment.
(6) After a certain time, the initiator transmits a DMG sensing report poll frame to the STA A to trigger the STA A to report a sensing measurement result.
(7) After the SIFS time, the STA A transmits a DMG sensing measurement report frame to the initiator to report the sensing measurement result.
(8) After the SIFS time, the initiator replies an ACK frame to the STA A.
(9) After the SIFS time, the initiator transmits a DMG sensing report poll frame to the STA B to trigger the STA B to report a sensing measurement result.
(10) After the SIFS time, the STA B transmits a DMG sensing measurement report frame to the initiator to report the sensing measurement result.
(11) After the SIFS time, the initiator replies an ACK frame to the STA B.

It should be noted that (8) and (11) above are optional steps. In the above example, only 2 responders are present, and in the case that more responders are present, subsequent responders can be triggered to transmit the DMG sensing measurement report frame continuously by using the above method. The above DMG sensing report poll frame is in the format shown in FIG. 14. In addition, the DMG sensing report poll frame used in the embodiments of the present disclosure may be replaced by a DMG sensing poll frame, and the DMG sensing poll frame is in the format shown in FIG. 10. That is, the DMG sensing poll frame can also trigger the responder to transmit the DMG sensing measurement report frame, and the initiator triggers the responder to transmit the DMG sensing measurement report frame by transmitting the DMG sensing poll frame to the responder.

Compared with the flow shown in FIG. 5, the difference is that the initiator needs to sequentially transmit the DMG sensing report poll frame to each responder to trigger the responder to transmit the DMG sensing measurement report frame, and that each responder feeds back the DMG sensing measurement report frame to the initiator within the SIFS time upon receiving the DMG sensing report poll frame, with other flows being the same.

In summary, according to the method provided in the embodiments, each sensing responder that participates in the coordinated sensing measurement is triggered by the sensing initiator over the sensing report poll frame to execute the report stage in the sensing measurement process, such that the time at which each sensing responder transmits the sensing measurement report frame is only related to the time at which the sensing responder receives the sensing report poll frame, but is not related to the times at which other sensing responders transmit the sensing measurement report frame, avoiding the problem that the coordinated sensing of a plurality of sensing devices cannot be normally performed. In addition, the sensing initiator directionally transmits the sensing report poll frame to each sensing responder, ensuring that each sensing responder receives the trigger signal reliably.

### For the Fifth Case Described Above:

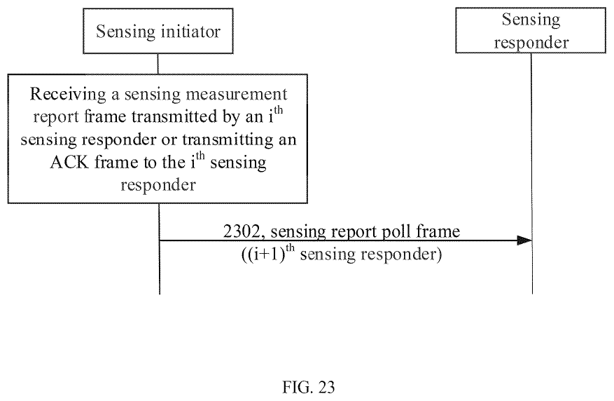

FIG. 23 is a flowchart of a method for coordinated sensing measurement according to some embodiments of the present disclosure. The method is applicable to the system as shown in FIG. 1, and the method includes the following step.

In step 2302: the sensing initiator transmits the sensing report poll frame to an (i+1)^{th} sensing responder upon receiving a sensing measurement report frame transmitted by an i^{th} sensing responder or transmitting an ACK frame to the i^{th} sensing responder.

The type of the coordinated sensing measurement in the embodiments is a parallel coordinated-monostatic mode, and each sensing responder except a first sensing responder corresponds to one sensing report poll frame. The sensing report poll frame is configured to trigger the sensing responder to transmit the sensing measurement report frame, and i is a positive integer.

After all the sensing responders receive the sensing request frame transmitted by the sensing initiator and reply with the sensing response frame, each sensing responder separately self-transmits and receives the monostatic sensing measurement frame simultaneously to sense the environment. Then the first sensing responder transmits the sensing measurement report frame to the sensing initiator.

In some embodiments, the sensing initiator transmits or does not transmit the ACK frame to the i^{th} sensing responder.

In the case that the ACK frame is transmitted, the sensing initiator transmits the sensing report poll frame to the (i+1)^{th} sensing responder upon transmitting the ACK frame to the i^{th} sensing responder. In the case that the ACK frame is not transmitted, the sensing initiator transmits the sensing report poll frame to the (i+1)^{th} sensing responder upon receiving the sensing measurement report frame transmitted by the i^{th} sensing responder.

Upon receiving the sensing report poll frame, the (i+1)^{th} sensing responder transmits the sensing measurement report frame to the sensing responder.

In some embodiments, a difference of an SIFS time is present between the sensing measurement report frame corresponding to the i^{th} sensing responder or the ACK frame corresponding to the i^{th} sensing responder and the sensing report poll frame corresponding to the (i+1)^{th} sensing responder.

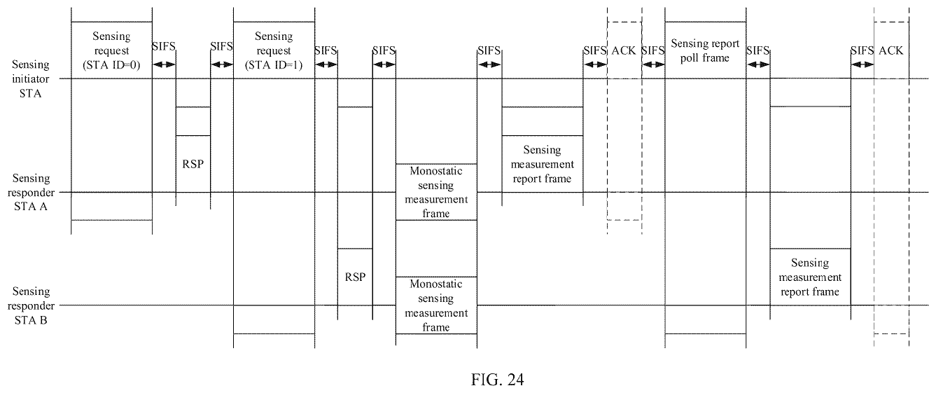

In a specific example, FIG. 24 is a schematic flowchart of a parallel mode of coordinated-monostatic sensing measurement according to some embodiments of the present disclosure. As shown in FIG. 24, the flow involves one initiator (STA) and two responders (STA A and STA B), and the flow includes the following processes (from left to right).
(1) The initiator transmits a DMG sensing request frame to the STA A, where “Num of STAs in instance”=2, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) After the SIFS time, the STA A and the STA B separately self-transmit and self-receive a monostatic sensing measurement frame simultaneously to sense the environment.
(6) After the SIFS time, the STA A transmits a DMG sensing measurement report frame to the initiator to report a sensing measurement result.
(7) After the SIFS time, the initiator replies an ACK frame to the STA A.
(8) After the SIFS time, the initiator transmits a DMG sensing report poll frame to the STA B to trigger the STA B to report a sensing measurement result.
(9) After the SIFS time, the STA B transmits a DMG sensing measurement report frame to the initiator to report the sensing measurement result.
(10) After the SIFS time, the initiator replies an ACK frame to the STA B.

It should be noted that (7) and (10) above are optional steps. In the above example, only 2 responders are present, and in the case that more responders are present, subsequent responders can be triggered to transmit the DMG sensing measurement report frame continuously by using the above method. The above DMG sensing report poll frame is in the format shown in FIG. 14. In addition, the DMG sensing report poll frame used in the embodiments of the present disclosure may be replaced by a DMG sensing poll frame, and the DMG sensing poll frame is in the format shown in FIG. 10. That is, the DMG sensing poll frame can also trigger the responder to transmit the DMG sensing measurement report frame, and the initiator triggers the responder to transmit the DMG sensing measurement report frame by transmitting the DMG sensing poll frame to the responder.

Compared with the flow shown in FIG. 22, the difference is that the first responder (STA A) actively transmits the DMG sensing measurement report frame to the initiator within the SIFS time after self-transmitting and self-receiving the monostatic sensing measurement frame, without waiting for the DMG sensing report poll frame transmitted by the initiator.

In summary, according to the method provided in the embodiments, each sensing responder that participates in the coordinated sensing measurement except a first sensing responder is triggered by the sensing initiator over the sensing report poll frame to execute the report stage in the sensing measurement process, such that the time at which each sensing responder except the first sensing responder transmits the sensing measurement report frame is only related to the time at which the sensing responder receives the sensing report poll frame, but is not related to the times at which other sensing responders transmit the sensing measurement report frame, avoiding the problem that the coordinated sensing of a plurality of sensing devices cannot be normally performed. In addition, the sensing initiator directionally transmits the sensing report poll frame to each sensing responder except the first sensing responder, ensuring that each sensing responder except the first sensing responder receives the trigger signal reliably.

### For the Sixth Case Described Above:

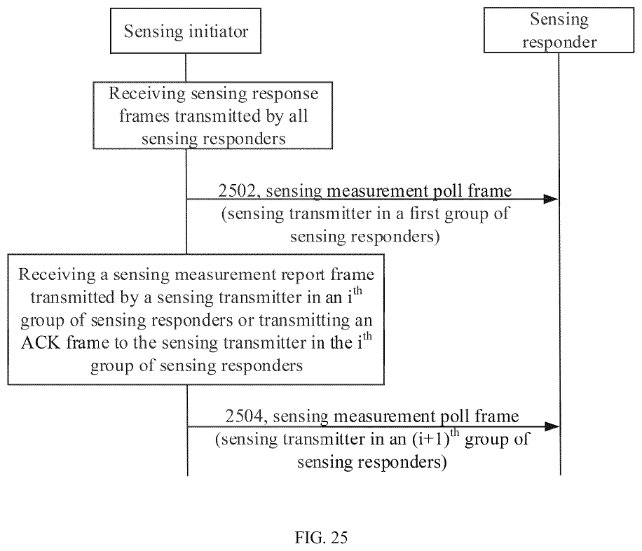

FIG. 25 is a flowchart of a method for coordinated sensing measurement according to some embodiments of the present disclosure. The method is applicable to the system as shown in FIG. 1, and the method includes the following steps.

In step 2502: the sensing initiator transmits the sensing measurement poll frame to the sensing transmitter in a first group of the sensing responders upon receiving sensing response frames transmitted by all the sensing responders.

The type of the coordinated sensing measurement in the embodiments is coordinated-bistatic, and each group of the sensing responders includes a sensing transmitter and a sensing receiver. Each group of the sensing responders corresponds to one sensing measurement poll frame, and the sensing measurement poll frame is configured to trigger the sensing transmitter to transmit a BRP frame carrying a TRN field.

Upon receiving the sensing measurement poll frame, the sensing transmitter in the first group of the sensing responders transmits the BRP frame with the TRN field to the sensing receiver in the first group and receives a BRP frame with Report transmitted by the sensing receiver to sense the environment, and then transmits the sensing measurement report frame to the sensing initiator.

In some embodiments, a difference of an SIFS time is present between the sensing response frame corresponding to the sensing receiver in a last group of the sensing responders and the sensing measurement poll frame corresponding to the sensing transmitter in the first group of the sensing responders.

In step 2504: the sensing initiator transmits the sensing measurement poll frame to the sensing transmitter in an (i+1)^{th} group of the sensing responders upon receiving a sensing measurement report frame transmitted by the sensing transmitter in an i^{th} group of the sensing responders or transmitting an ACK frame to the sensing transmitter in the i^{th} group of the sensing responders.

In some embodiments, the sensing initiator transmits or does not transmit the ACK frame to the sensing transmitter in the i^{th} group of the sensing responders.

In the case that the ACK frame is transmitted, the sensing initiator transmits the sensing measurement poll frame to the sensing transmitter in the (i+1)^{th} group of the sensing responders upon transmitting the ACK frame to the sensing transmitter in the i^{th} group of the sensing responders. In the case that the ACK frame is not transmitted, the sensing initiator transmits the sensing measurement poll frame to the sensing transmitter in the (i+1)^{th} group of the sensing responders upon receiving the sensing measurement report frame transmitted by the sensing transmitter in the i^{th} group of the sensing responders.

Upon receiving the sensing measurement poll frame, the sensing transmitter in the (i+1)^{th} group of the sensing responders transmits the BRP frame with the TRN field to the sensing receiver in the i^{th} group and receives a BRP frame with Report transmitted by the sensing receiver to sense the environment, and then transmits the sensing measurement report frame to the sensing initiator. Here, i is a positive integer.

In some embodiments, a difference of an SIFS time is present between the sensing measurement report frame corresponding to the sensing transmitter in the i^{th} group of the sensing responders or the ACK frame corresponding to the sensing transmitter in the i^{th} group of the sensing responders and the sensing measurement poll frame corresponding to the sensing transmitter in the (i+1)^{th} group of the sensing responders.

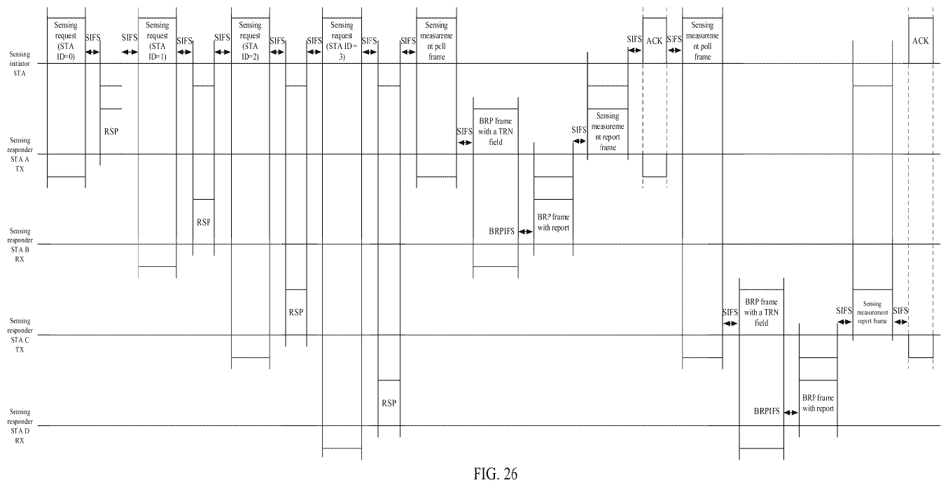

In a specific example, FIG. 26 is a schematic flowchart of coordinated-bistatic sensing measurement according to some embodiments of the present disclosure. As shown in FIG. 26, the flow involves one initiator (STA) and four responders (STA A, STA B, STA C, and STA D). The STA A and the STA B are grouped, and the STA C and the STA D are grouped. The STA A and the STA C are sensing transmitters, and the STA B and the STA D are sensing receivers (the role setting completed by the initiator in the sensing measurement setup stage). The following processes are included (from left to right).
(1) The initiator transmits a DMG sensing request frame to the STA A, where “Num of STAs in instance”=4, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) The initiator transmits a DMG sensing request frame to the STA C, where “Num of STAs in instance”=4, “Num of PPDUs”=1, and “STA ID”=2 are set.
(6) After the SIFS time, the STA C replies a DMG sensing response frame to the initiator.
(7) After the SIFS time, the initiator transmits a DMG sensing request frame to the STA D, where “Num of STAs in instance”=4, “Num of PPDUs”=1, and “STA ID”=3 are set.
(8) After the SIFS time, the STA D replies a DMG sensing response frame to the initiator.
(9) After the SIFS time, the initiator transmits a DMG sensing measurement poll frame to the STA A to trigger the STA A to start the bistatic sensing measurement with the STA B.
(10) After the SIFS time, the STA A transmits a BRP frame with a TRN field to the STA B to sense the environment.
(11) After a BRP interframe space (BRPIFS) time, the STA B replies a BRP frame with Report to the STA A.
(12) After the SIFS time, the STA A transmits a DMG sensing measurement report frame to the initiator to report a sensing measurement result.
(13) After the SIFS time, the initiator replies an ACK frame to the STA A.
(14) After the SIFS time, the initiator transmits a DMG sensing measurement poll frame to the STA C to trigger the STA C to start the sensing measurement.
(15) After the SIFS time, the STA C transmits a BRP frame with a TRN field to the STA D to sense the environment.
(16) After the BRPIFS time, the STA D replies a BRP frame with Report to the STA C.
(17) After the SIFS time, the STA C transmits a DMG sensing measurement report frame to the initiator to report a sensing measurement result.
(18) After the SIFS time, the initiator replies an ACK frame to the STA C.

It should be noted that (13) and (18) above are optional steps. In the above example, only 2 groups of the responders are present, and in the case that more groups of the responders are present, subsequent groups of the responders can be triggered to execute the bistatic sensing measurement continuously by using the above method. The above DMG sensing measurement report frame is in the format shown in FIG. 13 or in the format shown in FIG. 14. Compared with the flow shown in FIG. 6, the difference is that the initiator needs to sequentially transmit the DMG sensing measurement poll frame to the Tx in each group of the responders to trigger the bistatic sensing measurement, and the Tx in each group of the responders starts the bistatic sensing measurement with the Rx after the SIFS time since receiving the DMG sensing measurement poll frame, with other flows being the same.

In summary, according to the method provided in the embodiments, each group of the sensing responders that participates in the coordinated sensing measurement is triggered by the sensing initiator over the sensing measurement poll frame to execute the measurement stage and the report stage in the sensing measurement process, such that the time at which each group of the sensing responders executes the bistatic sensing measurement is only related to the time at which the group of the sensing responders receives the sensing measurement poll frame, but is not related to the times at which other groups of the sensing responders execute the bistatic sensing measurement, avoiding the problem that the coordinated sensing of a plurality of sensing devices cannot be normally performed. In addition, the sensing initiator directionally transmits the sensing measurement poll frame to the sensing transmitter in each group of the sensing responders, ensuring that each sensing transmitter receives the trigger signal reliably.

### For the Seventh Case Described Above:

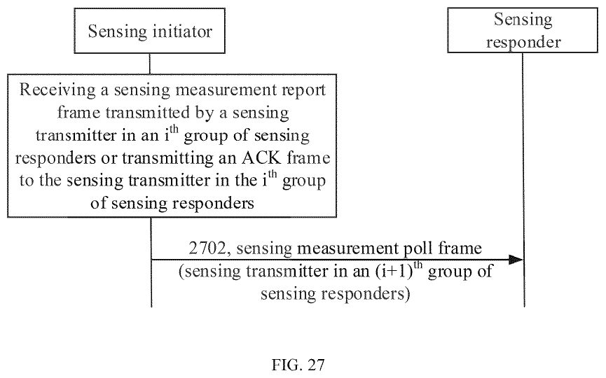

FIG. 27 is a flowchart of a method for coordinated sensing measurement according to some embodiments of the present disclosure. The method is applicable to the system as shown in FIG. 1, and the method includes the following step.

In step 2702: the sensing initiator transmits the sensing measurement poll frame to the sensing transmitter in an (i+1)^{th} group of the sensing responders upon receiving a sensing measurement report frame transmitted by the sensing transmitter in an i^{th} group of the sensing responders or transmitting an ACK frame to the sensing transmitter in the i^{th} group of the sensing responders.

The type of the coordinated sensing measurement in the embodiments is coordinated-bistatic, and each group of the sensing responders includes a sensing transmitter and a sensing receiver. Each group of the sensing responders except a first group of the sensing responders corresponds to one sensing measurement poll frame. The sensing measurement poll frame is configured to trigger the sensing transmitter to transmit a BRP frame carrying a TRN field. Here, i is a positive integer.

After all the sensing responders receive the sensing request frame transmitted by the sensing initiator and reply with the sensing response frame, the first group of the sensing responders executes the bistatic sensing measurement to sense the environment, and the sensing transmitter in the first group of the sensing responders transmits the sensing measurement report frame to the sensing initiator.

In some embodiments, the sensing initiator transmits or does not transmit the ACK frame to the sensing transmitter in the i^{th} group of the sensing responders.

In the case that the ACK frame is transmitted, the sensing initiator transmits the sensing measurement poll frame to the sensing transmitter in the (i+1)^{th} group of the sensing responders upon transmitting the ACK frame to the sensing transmitter in the i^{th} group of the sensing responders. In the case that the ACK frame is not transmitted, the sensing initiator transmits the sensing measurement poll frame to the sensing transmitter in the (i+1)^{th} group of the sensing responders upon receiving the sensing measurement report frame transmitted by the sensing transmitter in the i^{th} group of the sensing responders.

Upon receiving the sensing measurement poll frame, the sensing transmitter in the (i+1)^{th} group of the sensing responders transmits the BRP frame with the TRN field to the sensing receiver in the i^{th} group and receives a BRP frame with Report transmitted by the sensing receiver to sense the environment, and then transmits the sensing measurement report frame to the sensing initiator.

In some embodiments, a difference of an SIFS time is present between the sensing measurement report frame corresponding to the sensing transmitter in the i^{th} group of the sensing responders or the ACK frame corresponding to the sensing transmitter in the i^{th} group of the sensing responders and the sensing measurement poll frame corresponding to the sensing transmitter in the (i+1)^{th} group of the sensing responders.

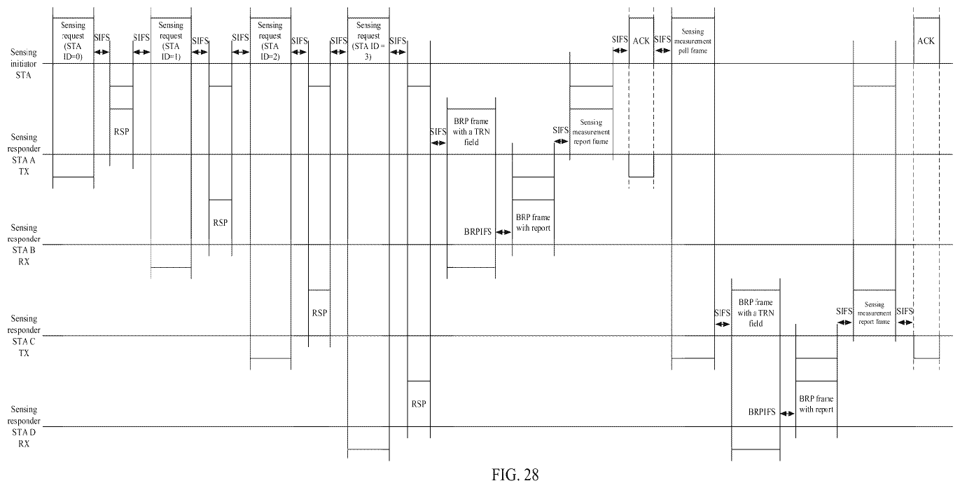

In a specific example, FIG. 28 is a schematic flowchart of coordinated-bistatic sensing measurement according to some embodiments of the present disclosure. As shown in FIG. 28, the flow involves one initiator (STA) and four responders (STA A, STA B, STA C, and STA D). The STA A and the STA B are grouped, and the STA C and the STA D are grouped. The STA A and the STA C are sensing transmitters, and the STA B and the STA D are sensing receivers (the role setting completed by the initiator in the sensing measurement setup stage). The following processes are included (from left to right).
(1) The initiator transmits a DMG sensing request frame to the STA A, where “Num of STAs in instance”=4, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) The initiator transmits a DMG sensing request frame to the STA C, where “Num of STAs in instance”=4, “Num of PPDUs”=1, and “STA ID”=2 are set.
(6) After the SIFS time, the STA C replies a DMG sensing response frame to the initiator.
(7) After the SIFS time, the initiator transmits a DMG sensing request frame to the STA D, where “Num of STAs in instance”=4, “Num of PPDUs”=1, and “STA ID”=3 are set.
(8) After the SIFS time, the STA D replies a DMG sensing response frame to the initiator.
(9) After the SIFS time, the STA A transmits a BRP frame with a TRN field to the STA B to sense the environment.
(10) After the BRPIFS time, the STA B replies a BRP frame with Report to the STA A.
(11) After the SIFS time, the STA A transmits a DMG sensing measurement report frame to the initiator to report a sensing measurement result.
(12) After the SIFS time, the initiator replies an ACK frame to the STA A.
(13) After the SIFS time, the initiator transmits a DMG sensing measurement poll frame to the STA C to trigger the STA C to start the sensing measurement.
(14) After the SIFS time, the STA C transmits a BRP frame with a TRN field to the STA D to sense the environment.
(15) After the BRPIFS time, the STA D replies a BRP frame with Report to the STA C.
(16) After the SIFS time, the STA C transmits a DMG sensing measurement report frame to the initiator to report a sensing measurement result.
(17) After the SIFS time, the initiator replies an ACK frame to the STA C.

It should be noted that (12) and (17) above are optional steps. In the above example, only 2 groups of the responders are present, and in the case that more groups of the responders are present, subsequent groups of the responders can be triggered to execute the bistatic sensing measurement continuously by using the above method. The above DMG sensing measurement report frame is in the format shown in FIG. 13 or in the format shown in FIG. 14. Compared with the flow shown in FIG. 26, the difference is that after the SIFS time since the last responder (STA D) replies the DMG sensing response frame to the initiator, the first responder (STA A) actively starts transmitting the BRP frame to the STA B to sense the environment, without waiting for the initiator to transmit the DMG sensing measurement poll frame.

In summary, according to the method provided in the embodiments, each group of the sensing responders that participates in the coordinated sensing measurement except a first group of the sensing responders is triggered by the sensing initiator over the sensing measurement poll frame to execute the measurement stage and the report stage in the sensing measurement process, such that the time at which each group of the sensing responders except the first group of the sensing responders executes the bistatic sensing measurement is only related to the time at which the group of the sensing responders receives the sensing measurement poll frame, but is not related to the times at which other groups of the sensing responders execute the bistatic sensing measurement, avoiding the problem that the coordinated sensing of a plurality of sensing devices cannot be normally performed. In addition, the sensing initiator directionally transmits the sensing measurement poll frame to the sensing transmitter in each group of the sensing responders except the first group of the sensing responders, ensuring that each sensing transmitter receives the trigger signal reliably.

### For the Eighth Case Described Above:

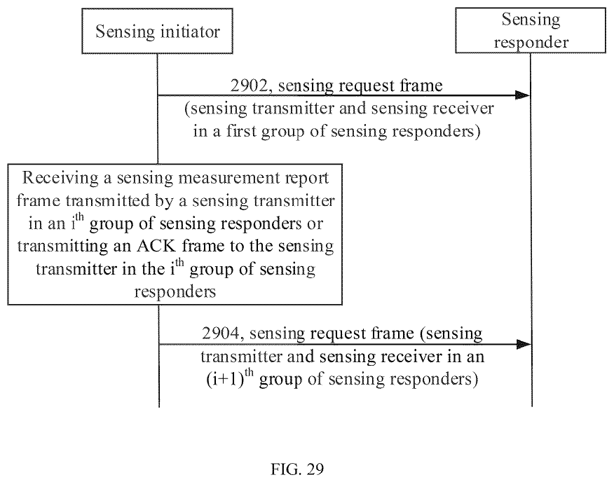

FIG. 29 is a flowchart of a method for coordinated sensing measurement according to some embodiments of the present disclosure. The method is applicable to the system as shown in FIG. 1, and the method includes the following steps.

In step 2902: the sensing initiator transmits the sensing request frame separately to the sensing transmitter and the sensing receiver in a first group of the sensing responders.

The type of the coordinated sensing measurement in the embodiments is coordinated-bistatic, and each sensing responder in a group of the sensing responders corresponds to one sensing request frame. Each group of the sensing responders includes a sensing transmitter and a sensing receiver. The sensing request frame is configured to trigger a group of the sensing responders to execute all the stages in the sensing measurement process.

After sequentially receiving the sensing request frame, the sensing transmitter and the sensing receiver in the first group of the sensing responders sequentially transmit the sensing response frame to the sensing initiator, and then the first group of the sensing responders executes the bistatic sensing measurement (including the sensing transmitter in the first group transmitting a BRP frame with a TRN field to the sensing receiver and receiving a BRP frame with Report transmitted by the sensing receiver) to sense the environment, and the sensing transmitter in the first group transmits the sensing measurement report frame to the sensing responder.

In step 2904: the sensing initiator transmits the sensing request frame separately to the sensing transmitter and the sensing receiver in an (i+1)^{th} group of the sensing responders upon receiving a sensing measurement report frame transmitted by the sensing transmitter in an i^{th} group of the sensing responders or transmitting an ACK frame to the sensing transmitter in the i^{th} group of the sensing responders.

In some embodiments, the sensing initiator transmits or does not transmit the ACK frame to the sensing transmitter in the i^{th} group of the sensing responders. In the case that the ACK frame is transmitted, the sensing initiator transmits the sensing request frame separately to the sensing transmitter and the sensing receiver in the (i+1)^{th} group of the sensing responders upon transmitting the ACK frame to the sensing transmitter in the i^{th} group of the sensing responders. In the case that the ACK frame is not transmitted, the sensing initiator transmits the sensing request frame separately to the sensing transmitter and the sensing receiver in the (i+1)^{th} group of the sensing responders upon receiving the sensing measurement report frame transmitted by the sensing transmitter in the i^{th} group of the sensing responders.

Upon receiving the sensing request frame, the sensing transmitter and the sensing receiver in the (i+1)^{th} group of the sensing responders separately transmit the sensing response frame to the sensing initiator, and then the (i+1)^{th} group of the sensing responders executes the bistatic sensing measurement to sense the environment, and the sensing transmitter in the (i+1)^{th} group transmits the sensing measurement report frame to the sensing responder. Here, i is a positive integer.

In some embodiments, a difference of an SIFS time is present between the sensing measurement report frame corresponding to the sensing transmitter in the i^{th} group of the sensing responders or the ACK frame corresponding to the sensing transmitter in the i^{th} group of the sensing responders and the sensing request frame corresponding to the sensing transmitter in the (i+1)^{th} group of the sensing responders.

In a specific example, FIG. 30 is a schematic flowchart of coordinated-bistatic sensing measurement according to some embodiments of the present disclosure. As shown in FIG. 30, the flow involves one initiator (STA) and four responders (STA A, STA B, STA C, and STA D). The STA A and the STA B are grouped, and the STA C and the STA D are grouped. The STA A and the STA C are sensing transmitters, and the STA B and the STA D are sensing receivers (the role setting completed by the initiator in the sensing measurement setup stage). The following processes are included (from left to right).
(1) The initiator transmits a DMG sensing request frame to the STA A, where “Num of STAs in instance”=4, “Num of PPDUs”=1, and “STA ID”=0 are set.
(2) After the SIFS time, the STA A replies a DMG sensing response frame to the initiator.
(3) After the SIFS time, the initiator transmits a DMG sensing request frame to the STA B, where “Num of STAs in instance”=2, “Num of PPDUs”=1, and “STA ID”=1 are set.
(4) After the SIFS time, the STA B replies a DMG sensing response frame to the initiator.
(5) After the SIFS time, the STA A transmits a BRP frame with a TRN field to the STA B to sense the environment.
(6) After the BRPIFS time, the STA B replies a BRP frame with Report to the STA A.
(7) After the SIFS time, the STA A transmits a DMG sensing measurement report frame to the initiator to report a sensing measurement result.
(8) After the SIFS time, the initiator replies an ACK frame to the STA A.
(9) The initiator transmits a DMG sensing request frame to the STA C, where “Num of STAs in instance”=4, “Num of PPDUs”=1, and “STA ID”=2 are set.
(10) After the SIFS time, the STA C replies a DMG sensing response frame to the initiator.
(11) After the SIFS time, the initiator transmits a DMG sensing request frame to the STA D, where “Num of STAs in instance”=4, “Num of PPDUs”=1, and “STA ID”=3 are set.
(12) After the SIFS time, the STA D replies a DMG sensing response frame to the initiator.
(13) After the SIFS time, the STA C transmits a BRP frame with a TRN field to the STA D to sense the environment.
(14) After the BRPIFS time, the STA D replies a BRP frame with Report to the STA C.
(15) After the SIFS time, the STA C transmits a DMG sensing measurement report frame to the initiator to report a sensing measurement result.
(16) After the SIFS time, the initiator replies an ACK frame to the STA C.

It should be noted that (8) and (16) above are optional steps. In the above example, only 2 groups of the responders are present, and in the case that more groups of the responders are present, subsequent groups of the responders can be triggered to execute the whole sensing measurement process by using the above method. The above DMG sensing request frame is in the format shown in FIG. 8. Compared with the flow shown in FIG. 6, the difference is that the initiator starts exchanging with a second group of the responders upon exchanging all frames with the first group of the responders. That is, after a group of the responders executes the whole sensing measurement process, the initiator triggers, through the DMG sensing request frame, the next group of the responders to execute the whole sensing measurement process.

In summary, according to the method provided in the embodiments, each group of the sensing responders that participates in the coordinated sensing measurement is triggered by the sensing initiator over the sensing request frame to execute the whole sensing measurement process, such that the time at which each group of the sensing responders starts executing the sensing measurement process is only related to the time at which the group of the sensing responders receives the sensing request frame, avoiding the problem that the coordinated sensing of a plurality of sensing devices cannot be normally performed.

It should be noted that the order of the different cases as described above does not have a preferred meaning, but is merely for convenience of description.

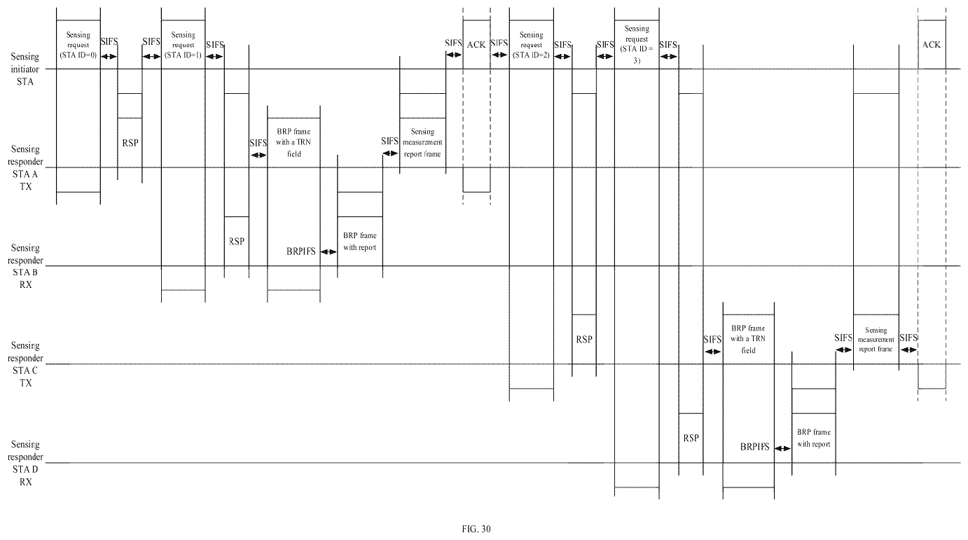

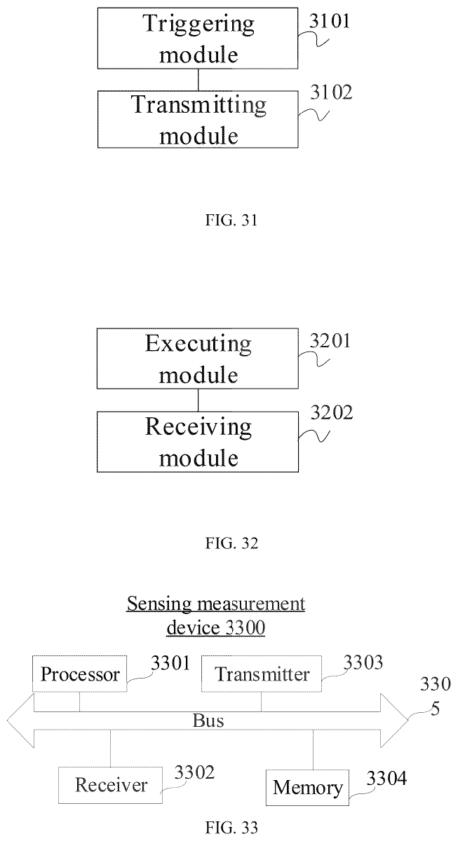

FIG. 31 is a block diagram of an apparatus for coordinated sensing measurement according to some embodiments of the present disclosure. As shown in FIG. 31, the apparatus includes:
a triggering module 3101, configured to trigger each group of or each of sensing responders that participate in the coordinated sensing measurement to execute all or a portion of stages in a sensing measurement process in a poll triggering mode during the coordinated sensing measurement.

In some embodiments, the poll triggering mode is implemented based on at least one type of:
sensing request frames;
sensing measurement poll frames; or
sensing report poll frames.

The sensing request frames are configured to trigger the sensing responder to execute all the stages in the sensing measurement process, the sensing measurement poll frames are configured to trigger the sensing responder to execute a sensing measurement stage and a report stage in the sensing measurement process, and the sensing report poll frames are configured to trigger the sensing responder to execute the report stage in the sensing measurement process.

In some embodiments, each group of or each of the sensing responders corresponds to one of the sensing measurement poll frames.

In some embodiments, a type of the coordinated sensing measurement is a sequential coordinated-monostatic mode. The apparatus further includes a transmitting module 3102, and the transmitting module 3102 is configured to:
transmit the sensing measurement poll frame to a first sensing responder upon receiving sensing response frames transmitted by all the sensing responders; and
transmit the sensing measurement poll frame to an (i+1)^{th} sensing responder upon receiving a sensing measurement report frame transmitted by an i^{th} sensing responder or transmitting an ACK frame to the i^{th} sensing responder.

The sensing measurement poll frame is configured to trigger the sensing responder to transmit a monostatic sensing measurement frame, and i is a positive integer.

In some embodiments, a type of the coordinated sensing measurement is coordinated-bistatic, and each group of the sensing responders includes one sensing transmitter and one sensing receiver. The apparatus further includes a transmitting module 3102, and the transmitting module 3102 is configured to:
transmit the sensing measurement poll frame to the sensing transmitter in a first group of the sensing responders upon receiving sensing response frames transmitted by all the sensing responders; and
transmit the sensing measurement poll frame to the sensing transmitter in an (i+1)^{th} group of the sensing responders upon receiving a sensing measurement report frame transmitted by the sensing transmitter in an i^{th} group of the sensing responders or transmitting an ACK frame to the sensing transmitter in the i^{th} group of the sensing responders.

The sensing measurement poll frame is configured to trigger the sensing transmitter to transmit a BRP frame carrying a TRN field, and i is a positive integer.

In some embodiments, each group of the sensing responders except a first group of the sensing responders or each of the sensing responders except a first sensing responder corresponds to one of the sensing measurement poll frames.

In some embodiments, a type of the coordinated sensing measurement is a sequential coordinated-monostatic mode. The apparatus further includes a transmitting module 3102, and the transmitting module 3102 is configured to:

transmit the sensing measurement poll frame to an (i+1)^{th} sensing responder upon receiving a sensing measurement report frame transmitted by an i^{th} sensing responder or transmitting an ACK frame to the i^{th} sensing responder.

The sensing measurement poll frame is configured to trigger the sensing responder to transmit a monostatic sensing measurement frame, and i is a positive integer.

In some embodiments, a type of the coordinated sensing measurement is coordinated-bistatic, and each group of the sensing responders includes one sensing transmitter and one sensing receiver. The apparatus further includes a transmitting module 3102, and the transmitting module 3102 is configured to:

transmit the sensing measurement poll frame to the sensing transmitter in an (i+1)^{th} group of the sensing responders upon receiving a sensing measurement report frame transmitted by the sensing transmitter in an i^{th} group of the sensing responders or transmitting an ACK frame to the sensing transmitter in the i^{th} group of the sensing responders.

The sensing measurement poll frame is configured to trigger the sensing transmitter to transmit a BRP frame carrying a TRN field, and i is a positive integer.

In some embodiments, each of the sensing responders in one group of the sensing responders corresponds to one of the sensing request frames, or each of the sensing responders corresponds to one of the sensing request frames.

In some embodiments, a type of the coordinated sensing measurement is a sequential coordinated-monostatic mode. The apparatus further includes a transmitting module 3102, and the transmitting module 3102 is configured to:
transmit the sensing request frame to a first sensing responder; and
transmit the sensing request frame to an (i+1)^{th} sensing responder upon receiving a sensing measurement report frame transmitted by an i^{th} sensing responder or transmitting an ACK frame to the i^{th} sensing responder.

The sensing request frame is configured to trigger one of the sensing responder to execute all the stages in the sensing measurement process, and i is a positive integer.

In some embodiments, a type of the coordinated sensing measurement is coordinated-bistatic, and each group of the sensing responders includes a sensing transmitter and a sensing receiver. The apparatus further includes a transmitting module 3102, and the transmitting module 3102 is configured to:
transmit the sensing request frame separately to the sensing transmitter and the sensing receiver in a first group of the sensing responders; and
transmit the sensing request frame separately to the sensing transmitter and the sensing receiver in an (i+1)^{th} group of the sensing responders upon receiving a sensing measurement report frame transmitted by the sensing transmitter in an i^{th} group of the sensing responders or transmitting an ACK frame to the sensing transmitter in the i^{th} group of the sensing responders.

The sensing request frame is configured to trigger one group of the sensing responders to execute all the stages in the sensing measurement process, and i is a positive integer.

In some embodiments, each of the sensing responders corresponds to one of the sensing report poll frames.

In some embodiments, a type of the coordinated sensing measurement is a parallel coordinated-monostatic mode. The apparatus further includes a transmitting module 3102, and the transmitting module 3102 is configured to:
transmit the sensing report poll frame to a first sensing responder after the first sensing responder transmits and receives a monostatic sensing measurement frame; and
transmit the sensing report poll frame to an (i+1)^{th} sensing responder upon receiving a sensing measurement report frame transmitted by an i^{th} sensing responder or transmitting an ACK frame to the i^{th} sensing responder.

The sensing report poll frame is configured to trigger the sensing responder to transmit the sensing measurement report frame, and i is a positive integer.

In some embodiments, each of the sensing responders except a first sensing responder corresponds to one of the sensing report poll frames.

In some embodiments, a type of the coordinated sensing measurement is a parallel coordinated-monostatic mode. The apparatus further includes a transmitting module 3102, and the transmitting module 3102 is configured to:
transmit the sensing report poll frame to an (i+1)^{th} sensing responder upon receiving a sensing measurement report frame transmitted by an i^{th} sensing responder or transmitting an ACK frame to the i^{th} sensing responder.

The sensing report poll frame is configured to trigger the sensing responder to transmit the sensing measurement report frame, and i is a positive integer.

In some embodiments, the sensing measurement poll frame is a TDD beamforming frame.

In some embodiments, a MAC frame body of the TDD beamforming frame includes a TDD beamforming control field, and the TDD beamforming control field includes a TDD group beamforming field and a TDD beam measurement field.

In the case that a value of the TDD group beamforming field is 1 and a value of the TDD beam measurement field is 1, the TDD beamforming frame is the sensing measurement poll frame.

In some embodiments, the sensing measurement poll frame is a sensing poll frame with a poll type field added in a TDD beamforming control field in a MAC frame body, and the poll type field indicates that the sensing poll frame added with the poll type field is the sensing measurement poll frame.

In some embodiments, in the case that a value of the poll type field is 0 or 1, the sensing poll frame added with the poll type field is the sensing measurement poll frame.

In some embodiments, the sensing report poll frame is a sensing poll frame with a poll type field added in a TDD beamforming control field in a MAC frame body, and the poll type field indicates that the sensing poll frame added with the poll type field is the sensing report poll frame.

In some embodiments, in the case that a value of the poll type field is 0 or 1, the sensing poll frame added with the poll type field is the sensing report poll frame.

FIG. 32 is a block diagram of an apparatus for coordinated sensing measurement according to some embodiments of the present disclosure. As shown in FIG. 32, the apparatus includes:

an executing module 3201, configured to execute, by each group of or each of the apparatuses that participate in the coordinated sensing measurement, all or a portion of stages in a sensing measurement process based on a trigger by a sensing initiator in a poll triggering mode during the coordinated sensing measurement.

In some embodiments, the poll triggering mode is implemented based on at least one type of:
sensing request frames;
sensing measurement poll frames; or
sensing report poll frames.

The sensing request frames are configured to trigger the apparatus to execute all the stages in the sensing measurement process, the sensing measurement poll frames are configured to trigger the apparatus to execute a sensing measurement stage and a report stage in the sensing measurement process, and the sensing report poll frames are configured to trigger the apparatus to execute the report stage in the sensing measurement process.

In some embodiments, each group of or each of the apparatuses corresponds to one of the sensing measurement poll frames.

In some embodiments, a type of the coordinated sensing measurement is a sequential coordinated-monostatic mode. The apparatus further includes a receiving module 3202, and the receiving module 3202 is configured to:
receive, by a first apparatus, the sensing measurement poll frame transmitted by the sensing initiator after the sensing initiator receives sensing response frames transmitted by all the apparatuses; and
receive, by an (i+1)^{th} apparatus, the sensing measurement poll frame transmitted by the sensing initiator after the sensing initiator receives a sensing measurement report frame transmitted by an i^{th} apparatus or transmits an ACK frame to the i^{th} apparatus.

The sensing measurement poll frame is configured to trigger the apparatus to transmit a monostatic sensing measurement frame, and i is a positive integer.

In some embodiments, a type of the coordinated sensing measurement is coordinated-bistatic, and each group of the apparatuses includes one sensing transmitter and one sensing receiver. The apparatus further includes a receiving module 3202, and the receiving module 3202 is configured to:
receive, by the sensing transmitter in a first group of the apparatuses, the sensing measurement poll frame transmitted by the sensing initiator after the sensing initiator receives sensing response frames transmitted by all the apparatuses; and
receive, by the sensing transmitter in an (i+1)^{th} group of the apparatuses, the sensing measurement poll frame transmitted by the sensing initiator after the sensing initiator receives a sensing measurement report frame transmitted by the sensing transmitter in an i^{th} group of the apparatuses or transmits an ACK frame to the sensing transmitter in the i^{th} group of the apparatuses.

The sensing measurement poll frame is configured to trigger the sensing transmitter to transmit a BRP frame carrying a TRN field, and i is a positive integer.

In some embodiments, each group of the apparatuses except a first group of the apparatuses or each of the apparatuses except a first apparatus corresponds to one of the sensing measurement poll frames.

In some embodiments, a type of the coordinated sensing measurement is a sequential coordinated-monostatic mode. The apparatus further includes a receiving module 3202, and the receiving module 3202 is configured to:
receive, by an (i+1)^{th} apparatus, the sensing measurement poll frame transmitted by the sensing initiator after the sensing initiator receives a sensing measurement report frame transmitted by an i^{th} apparatus or transmits an ACK frame to the i^{th} apparatus.

The sensing measurement poll frame is configured to trigger the apparatus to transmit a monostatic sensing measurement frame, and i is a positive integer.

In some embodiments, a type of the coordinated sensing measurement is coordinated-bistatic, and each group of the apparatuses includes one sensing transmitter and one sensing receiver. The apparatus further includes a receiving module 3202, and the receiving module 3202 is configured to:
receive, by the sensing transmitter in an (i+1)^{th} group of the apparatuses, the sensing measurement poll frame transmitted by the sensing initiator after the sensing initiator receives a sensing measurement report frame transmitted by the sensing transmitter in an i^{th} group of the apparatuses or transmits an ACK frame to the sensing transmitter in the i^{th} group of the apparatuses.

The sensing measurement poll frame is configured to trigger the sensing transmitter to transmit a BRP frame carrying a TRN field, and i is a positive integer.

In some embodiments, each of the apparatuses in one group of the apparatuses corresponds to one of the sensing request frames, or each of the apparatuses corresponds to one of the sensing request frames.

In some embodiments, a type of the coordinated sensing measurement is a sequential coordinated-monostatic mode. The apparatus further includes a receiving module 3202, and the receiving module 3202 is configured to:
receive, by a first apparatus, the sensing request frame transmitted by the sensing initiator; and
receive, by an (i+1)^{th} apparatus, the sensing request frame transmitted by the sensing initiator after the sensing initiator receives a sensing measurement report frame transmitted by an i^{th} apparatus or transmits an ACK frame to the i^{th} apparatus.

The sensing request frame is configured to trigger one of the apparatus to execute all the stages in the sensing measurement process, and i is a positive integer.

In some embodiments, a type of the coordinated sensing measurement is coordinated-bistatic, and each group of the apparatuses includes a sensing transmitter and a sensing receiver.

The apparatus further includes a receiving module 3202, and the receiving module 3202 is configured to:
receive, separately by the sensing transmitter and the sensing receiver in a first group of the apparatuses, the sensing request frame transmitted by the sensing initiator; and
receive, separately by the sensing transmitter and the sensing receiver in an (i+1)^{th} group of the apparatuses, the sensing request frame transmitted by the sensing initiator after the sensing initiator receives a sensing measurement report frame transmitted by the sensing transmitter in an i^{th} group of the apparatuses or transmits an ACK frame to the sensing transmitter in the i^{th} group of the apparatuses.

The sensing request frame is configured to trigger one group of the apparatuses to execute all the stages in the sensing measurement process, and i is a positive integer.

In some embodiments, each of the apparatuses corresponds to one of the sensing report poll frames.

In some embodiments, a type of the coordinated sensing measurement is a parallel coordinated-monostatic mode. The apparatus further includes a receiving module 3202, and the receiving module 3202 is configured to:
receive, by a first apparatus, the sensing report poll frame transmitted by the sensing initiator after the first apparatus transmits and receives a monostatic sensing measurement frame; and
receive, by an (i+1)^{th} apparatus, the sensing report poll frame transmitted by the sensing initiator after the sensing initiator receives a sensing measurement report frame transmitted by an i^{th} apparatus or transmits an ACK frame to the i^{th} apparatus.

The sensing report poll frame is configured to trigger the apparatus to transmit the sensing measurement report frame, and i is a positive integer.

In some embodiments, each of the apparatuses except a first apparatus corresponds to one of the sensing report poll frames.

In some embodiments, a type of the coordinated sensing measurement is a parallel coordinated-monostatic mode. The apparatus further includes a receiving module 3202, and the receiving module 3202 is configured to:
receive, by an (i+1)^{th} apparatus, the sensing report poll frame transmitted by the sensing initiator after the sensing initiator receives a sensing measurement report frame transmitted by an i^{th} apparatus or transmits an ACK frame to the i^{th} apparatus.

The sensing report poll frame is configured to trigger the apparatus to transmit the sensing measurement report frame, and i is a positive integer.

In some embodiments, the sensing measurement poll frame is a TDD beamforming frame.

In some embodiments, a MAC frame body of the TDD beamforming frame includes a TDD beamforming control field, and the TDD beamforming control field includes a TDD group beamforming field and a TDD beam measurement field.

In the case that a value of the TDD group beamforming field is 1 and a value of the TDD beam measurement field is 1, the TDD beamforming frame is the sensing measurement poll frame.

In some embodiments, the sensing measurement poll frame is a sensing poll frame with a poll type field added in a TDD beamforming control field in a MAC frame body, and the poll type field indicates that the sensing poll frame added with the poll type field is the sensing measurement poll frame.

In some embodiments, in the case that a value of the poll type field is 0 or 1, the sensing poll frame added with the poll type field is the sensing measurement poll frame.

In some embodiments, the sensing report poll frame is a sensing poll frame with a poll type field added in a TDD beamforming control field in a MAC frame body, and the poll type field indicates that the sensing poll frame added with the poll type field is the sensing report poll frame.

In some embodiments, in the case that a value of the poll type field is 0 or 1, the sensing poll frame added with the poll type field is the sensing report poll frame.

It should be noted that, in the case that the apparatus according to the above embodiments implements the functions thereof, the division of the functional modules is merely exemplary. In practical application, the above functions may be assigned to different functional modules according to actual needs, i.e., the internal structure of the device may be divided into different functional modules, so as to implement all or a part of the above functions.

With regard to the apparatus in the above embodiments, the specific manner in which each module performs the operation has been described in detail in the embodiments related to the method and will not be described in detail herein.

FIG. 33 is a schematic structural diagram of a sensing measurement device (sensing initiator and/or sensing responder) according to some embodiments of the present disclosure. The sensing measurement device 3300 includes: a processor 3301, a receiver 3302, a transmitter 3303, a memory 3304, and a bus 3305.

The processor 3301 includes one or more processing cores, and the processor 3301 performs various functional applications and information processing by running software programs and modules.

The receiver 3302 and the transmitter 3303 are implemented as a communication assembly, which may be a communication chip.

The memory 3304 is connected to the processor 3301 through the bus 3305. The memory 3304 is configured to store at least one instruction, and the processor 3301 is configured to execute the at least one instruction to perform the steps in the above method embodiments.

In addition, the memory 3304 may be implemented using any type of transitory or non-transitory storage device, or a combination of both. Transitory or non-transitory storage devices include, but are not limited to: magnetic or optical disks, electrically erasable programmable read-only memory (EEPROM), erasable programmable read-only memory (EPROM), static random-access memory (SRAM), read-only memory (ROM), magnetic memory, flash memory, and programmable read-only memory (PROM).

The embodiments of the present disclosure further provide a computer-readable storage medium. The computer-readable storage medium stores one or more computer programs therein, where the one or more computer programs, when loaded and run by a sensing measurement device, cause the sensing measurement device to perform the above methods for coordinated sensing measurement applicable to the sensing measurement device (sensing initiator and/or sensing responder).

In some embodiments, the computer-readable storage medium includes read-only memory (ROM), random-access memory (RAM), solid state drives (SSD), or optical discs. Here, the random-access memory includes resistance random access memory (ReRAM) and dynamic random access memory (DRAM).

The embodiments of the present disclosure further provide a chip. The chip includes one or more programmable logic circuits and/or one or more program instructions, where a sensing measurement device equipped with the chip, when loading and running the one or more programmable logic circuits and/or the one or more program instructions, is caused to perform the above methods for coordinated sensing measurement applicable to the sensing measurement device.

The embodiments of the present disclosure further provide a computer program product or computer program. The computer program product or computer program includes one or more computer instructions stored in a computer-readable storage medium, where the one or more computer instructions, when read from the computer-readable storage medium and executed by a sensing measurement device, cause the sensing measurement device to perform the above methods for coordinated sensing measurement applicable to the sensing measurement device.

Those skilled in the art should appreciate that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely optional embodiments of the present disclosure and are not intended to limit the present disclosure. Any modifications, equivalent substitutions, improvements, and the like, made within the principle of the present disclosure should fall within the protection scope of the present disclosure.

1. A method for coordinated sensing measurement, applicable to a sensing initiator, the method comprising:
during a coordinated sensing measurement, triggering each group of or each of sensing responders that participate in the coordinated sensing measurement to execute all or a portion of stages in a sensing measurement process in a poll triggering mode.

2. The method according to claim 1, wherein the poll triggering mode is implemented based on at least one type of:
sensing request frames;
sensing measurement poll frames; or
sensing report poll frames;
wherein the sensing request frames are configured to trigger the sensing responder to execute all the stages in the sensing measurement process, the sensing measurement poll frames are configured to trigger the sensing responder to execute a sensing measurement stage and a report stage in the sensing measurement process, and the sensing report poll frames are configured to trigger the sensing responder to execute the report stage in the sensing measurement process.

3. The method according to claim 2, wherein each of the sensing responders in one group of the sensing responders corresponds to one of the sensing request frames, or each of the sensing responders corresponds to one of the sensing request frames.

4. The method according to claim 3, wherein:
a type of the coordinated sensing measurement is a sequential coordinated-monostatic mode; and
triggering each of the sensing responders that participate in the coordinated sensing measurement to execute all the stages in the sensing measurement process in the poll triggering mode comprises:
transmitting the sensing request frame to a first sensing responder; and
transmitting the sensing request frame to an (i+1)^{th} sensing responder upon receiving a sensing measurement report frame transmitted by an i^{th} sensing responder or transmitting an ACK frame to the i^{th} sensing responder;
the sensing request frame is configured to trigger one of the sensing responders to execute all the stages in the sensing measurement process, and i is a positive integer.

5. The method according to claim 2, wherein each of the sensing responders corresponds to one of the sensing report poll frames.

6. The method according to claim 5, wherein:
a type of the coordinated sensing measurement is a parallel coordinated-monostatic mode; and
triggering each of the sensing responders that participate in the coordinated sensing measurement to execute the portion of stages in the sensing measurement process in the poll triggering mode comprises:
transmitting the sensing report poll frame to a first sensing responder after the first sensing responder transmits and receives a monostatic sensing measurement frame; and
transmitting the sensing report poll frame to an (i+1)^{th} sensing responder upon receiving a sensing measurement report frame transmitted by an i^{th} sensing responder or transmitting an ACK frame to the i^{th} sensing responder;
the sensing report poll frame is configured to trigger the sensing responder to transmit the sensing measurement report frame, and i is a positive integer.

7. A method for coordinated sensing measurement, applicable to a sensing responder, the method comprising:
during a coordinated sensing measurement, executing, by each group of or each of the sensing responders that participate in the coordinated sensing measurement, all or a portion of stages in a sensing measurement process based on a trigger by a sensing initiator in a poll triggering mode.

8. The method according to claim 7, wherein the poll triggering mode is implemented based on at least one type of:
sensing request frames;
sensing measurement poll frames; or
sensing report poll frames;
wherein the sensing request frames are configured to trigger the sensing responder to execute all the stages in the sensing measurement process, the sensing measurement poll frames are configured to trigger the sensing responder to execute a sensing measurement stage and a report stage in the sensing measurement process, and the sensing report poll frames are configured to trigger the sensing responder to execute the report stage in the sensing measurement process.

9. The method according to claim 8, wherein each of the sensing responders in one group of the sensing responders corresponds to one of the sensing request frames, or each of the sensing responders corresponds to one of the sensing request frames.

10. The method according to claim 9, wherein:
a type of the coordinated sensing measurement is a sequential coordinated-monostatic mode; and
executing, by each of the sensing responders that participate in coordinated sensing measurement, all the stages in the sensing measurement process based on the trigger by the sensing initiator in the poll triggering mode comprises:
receiving, by a first sensing responder, the sensing request frame transmitted by the sensing initiator; and
receiving, by an (i+1)^{th} sensing responder, the sensing request frame transmitted by the sensing initiator after the sensing initiator receives a sensing measurement report frame transmitted by an i^{th} sensing responder or transmits an ACK frame to the i^{th} sensing responder;
the sensing request frame is configured to trigger one of the sensing responder to execute all the stages in the sensing measurement process, and i is a positive integer.

11. The method according to claim 8, wherein each of the sensing responders corresponds to one of the sensing report poll frames.

12. The method according to claim 11, wherein:
a type of the coordinated sensing measurement is a parallel coordinated-monostatic mode; and
executing, by each of the sensing responders that participate in the coordinated sensing measurement, the portion of stages in the sensing measurement process based on the trigger by the sensing initiator in the poll triggering mode comprises:
receiving, by a first sensing responder, the sensing report poll frame transmitted by the sensing initiator after the first sensing responder transmits and receives a monostatic sensing measurement frame; and
receiving, by an (i+1)^{th} sensing responder, the sensing report poll frame transmitted by the sensing initiator after the sensing initiator receives a sensing measurement report frame transmitted by an i^{th} sensing responder or transmits an ACK frame to the i^{th} sensing responder,
wherein the sensing report poll frame is configured to trigger the sensing responder to transmit the sensing measurement report frame, and i is a positive integer.

13. A sensing initiating device, comprising:
a processor;
a transceiver, connected to the processor; and
a memory, configured to store one or more executable instructions, which when executed by the processor, cause the sensing initiating device to:
during a coordinated sensing measurement, trigger each group of or each of sensing responders that participate in the coordinated sensing measurement to execute all or a portion of stages in a sensing measurement process in a poll triggering mode.

14. The sensing initiating device according to claim 13, wherein the poll triggering mode is implemented based on at least one type of:
sensing request frames;
sensing measurement poll frames; or
sensing report poll frames;
wherein the sensing request frames are configured to trigger the sensing responder to execute all the stages in the sensing measurement process, the sensing measurement poll frames are configured to trigger the sensing responder to execute a sensing measurement stage and a report stage in the sensing measurement process, and the sensing report poll frames are configured to trigger the sensing responder to execute the report stage in the sensing measurement process.

15. The sensing initiating device according to claim 14, wherein each of the sensing responders in one group of the sensing responders corresponds to one of the sensing request frames, or each of the sensing responders corresponds to one of the sensing request frames.

16. The sensing initiating device according to claim 15, wherein:
a type of the coordinated sensing measurement is a sequential coordinated-monostatic mode; and
wherein the one or more executable instructions, which when executed by the processor, further cause the sensing initiating device to:
transmit the sensing request frame to a first sensing responder; and
transmit the sensing request frame to an (i+1)^{th} sensing responder upon receiving a sensing measurement report frame transmitted by an i^{th} sensing responder or transmitting an ACK frame to the i^{th} sensing responder;
wherein the sensing request frame is configured to trigger one of the sensing responders to execute all the stages in the sensing measurement process, and i is a positive integer.

17. A sensing responding device, comprising:
a processor;
a transceiver, connected to the processor; and
a memory, configured to store one or more executable instructions, which when executed by the processor, cause the processor to perform the method for coordinated sensing measurement according to claim 7.

18. The sensing responding device according to claim 17, wherein the poll triggering mode is implemented based on at least one type of:
sensing request frames;
sensing measurement poll frames; or
sensing report poll frames;
wherein the sensing request frames are configured to trigger the sensing responder to execute all the stages in the sensing measurement process, the sensing measurement poll frames are configured to trigger the sensing responder to execute a sensing measurement stage and a report stage in the sensing measurement process, and the sensing report poll frames are configured to trigger the sensing responder to execute the report stage in the sensing measurement process.

19. The sensing responding device according to claim 18, wherein each of the sensing responders corresponds to one of the sensing report poll frames.

20. The sensing responding device according to claim 19, wherein a type of the coordinated sensing measurement is a parallel coordinated-monostatic mode; and
wherein one or more executable instructions, which when executed by the processor, further cause the processor to:
receiving, by a first sensing responder, the sensing report poll frame transmitted by the sensing initiator after the first sensing responder transmits and receives a monostatic sensing measurement frame; and
receiving, by an (i+1)^{th} sensing responder, the sensing report poll frame transmitted by the sensing initiator after the sensing initiator receives a sensing measurement report frame transmitted by an i^{th} sensing responder or transmits an ACK frame to the i^{th} sensing responder;
wherein the sensing report poll frame is configured to trigger the sensing responder to transmit the sensing measurement report frame, and i is a positive integer.
